(19) United States
(12) Patent Application Publication
(10) Pub. No.: US 2020/0258267 A1
(43) Pub. Date: Aug. 13, 2020

(54) IMAGE PROCESSING DEVICE FOR GAS DETECTION, IMAGE PROCESSING METHOD FOR GAS DETECTION, AND IMAGE PROCESSING PROGRAM FOR GAS DETECTION

(71) Applicant: KONICA MINOLTA, INC., Tokyo (JP)

(72) Inventor: Motohiro ASANO, Osaka (JP)

(21) Appl. No.: 16/639,367

(22) PCT Filed: Aug. 24, 2018
(86) PCT No.: PCT/JP2018/031286

§ 371 Date: Feb. 14, 2020

(30) Foreign Application Priority Data
Sep. 21, 2017 (JP) 2017-181283

(51) Int. Cl. G06T 11/00; G01M 3/38; G06T 1/20

(52) U.S. Cl. CPC G06T 11/001; G06T 1/20; G01M 3/38

(57) ABSTRACT

An image processing device for gas detection includes a first generation unit and a display control unit. The first generation unit obtains first time-series images whose imaging time is a first predetermined time period, sets a plurality of second predetermined time periods arranged in a time series and included in the first predetermined time period, and generates, for a plurality of second time-series images respectively corresponding to the plurality of second predetermined time periods, a representative image of a part (second time-series images) of the first time-series images corresponding to the second predetermined time period, thereby generating time-series representative images. The first generation unit generates a representative image including a gas region in the case of generating the representative image using the second time-series images including the gas region. The display control unit displays a plurality of representative images included in the time-series representative images in a time-series order.

### TECHNICAL FIELD

The present invention relates to a technique for detecting gas using an image.

### BACKGROUND ART

When a gas leak occurs, a slight temperature change occurs in the area where the leaked gas is drifting. As a technique for detecting gas using this principle, gas detection using an infrared image has been known.

As the gas detection using an infrared image, for example, Patent Literature 1 discloses a gas leak detection apparatus that includes an infrared camera for imaging an area to be inspected, and an image processing unit for processing the infrared image captured by the infrared camera, in which the image processing unit includes an extraction unit for extracting dynamic fluctuation caused by a gas leak from a plurality of infrared images arranged in a time series.

As the gas detection using an image other than the gas detection using an infrared image, for example, gas detection using an optical flow has been proposed. Patent Literature 2 discloses a gas leak detection system that is a system for detecting a gas leak on the basis of imaging by a long-focus optical system, which includes an imaging means for continuously capturing an object irradiated with parallel light or light similar to the parallel light using a camera of the long-focus optical system, a computing means for converting, using an optical flow process, the continuous image data captured by the imaging means into vector display image data in which a motion of particles in a plurality of image data is displayed as a vector, and an output means for outputting and displaying the vector display image data converted by the computing means.

A gas region extracted by image processing may be generated on the basis of an event other than appearance of the gas to be detected. For example, when the sun is obstructed by moving clouds and shadows of steam or the like reflected on a reflective surface on which sunlight is reflected is fluctuating, the resulting images may be included in the image as a gas region. Therefore, in the case of a gas detection technique based on a time-series image (e.g., moving image) having been subject to image processing of extracting a gas region, even if gas detection (gas region detection) is carried out, a user may determine that there is a possibility of misdetection in consideration of weather conditions (wind, weather), a time zone (daytime, night-time), and the like at the time of the gas detection.

In such a case, while the user determines whether or not it is misdetection by viewing the gas region included in the image, there may be a case where misdetection cannot be determined by viewing only the image at the time of the gas detection. In view of the above, the user views motions, changes in shape, and the like in the gas region in the past before the time at which the gas is detected, thereby determining whether or not it is misdetection. Furthermore, in the case of the shadow fluctuation mentioned above, the user determines whether or not it is misdetection by viewing whether or not a similar gas region is detected when the sun is not obstructed by clouds in the same time zone at the position with the same positional relationship with the sun. In order to make this determination, it is conceivable to go back from the time point at which the gas is detected and reproduce the time-series images. However, in a case where the retroactive period of time is long (e.g., one day or one week), the reproduction time of the time-series images becomes long, and the user cannot quickly determine whether or not it is misdetection. If the time-series images are subject to fast-forward reproduction, a gas region included in the image may be missed.

### CITATION LIST

### Patent Literature

Patent Literature 1: JP 2012-58093 A

Patent Literature 2: JP 2009-198399 A

### SUMMARY OF INVENTION

### Technical Problem

The present invention aims to provide an image processing device for gas detection, an image processing method for gas detection, and an image processing program for gas detection that enable a user to grasp contents of a time-series image in a short time without missing a gas region included in the image.

### Solution to Problem

In order to achieve the object mentioned above, an image processing device for gas detection reflecting one aspect of the present invention includes a first generation unit and a display control unit. The first generation unit obtains first time-series images whose imaging time is a first predetermined time period, sets a plurality of second predetermined time periods arranged in a time series and included in the first predetermined time period, and generates, for a plurality of second time-series images respectively corresponding to the plurality of second predetermined time periods, a representative image of the second time-series images corresponding to the second predetermined time period and to a part of the first time-series images, thereby generating time-series representative images. The first generation unit generates, in the case of generating the representative image using the second time-series images including a gas region, the representative image including the gas region. The display control unit displays, on a display, a plurality of the representative images included in the time-series representative images in a time-series order.

Advantages and features provided by one or a plurality of embodiments of the invention are fully understood from the following detailed descriptions and the accompanying drawings. Those detailed descriptions and the accompanying drawings are provided merely as examples, and are not intended to be definition of limitation of the present invention.

### BRIEF DESCRIPTION OF DRAWINGS

FIG. 1A is a block diagram illustrating a configuration of a gas detection system according to an embodiment.

FIG. 1B is a block diagram illustrating a hardware configuration of an image processing device for gas detection illustrated in FIG. 1A.

FIG. 2 is an explanatory diagram illustrating time-series pixel data D1.

FIG. 3 is an image diagram illustrating, in a time series, infrared images of an outdoor test site captured while a gas leak and a background temperature change are occurring in parallel.

FIG. 4A is a graph illustrating a temperature change at a spot SP1 in the test site.

FIG. 4B is a graph illustrating a temperature change at a spot SP2 in the test site.

FIG. 5 is a flowchart illustrating a process of generating a monitoring image.

FIG. 6 is a graph illustrating time-series pixel data D1 of a pixel corresponding to the spot SP1 (FIG. 3), low-frequency component data D2 extracted from the time-series pixel data D1, and high-frequency component data D3 extracted from the time-series pixel data D1.

FIG. 7A is a graph illustrating difference data D4.

FIG. 7B is a graph illustrating difference data D5.

FIG. 8 is a graph illustrating standard deviation data D6 and standard deviation data D7.

FIG. 9 is a graph illustrating difference data D8.

FIG. 10 is an image diagram illustrating an image I10, an image I11, and an image I12 generated on the basis of a frame at time T1.

FIG. 11 is an image diagram illustrating an image I13, an image I14, and an image I15 generated on the basis of a frame at time T2.

FIG. 12 is a flowchart illustrating various processes to be executed in the embodiment.

FIG. 13 is a schematic diagram illustrating a process of generating representative image video from monitoring image video according to the embodiment.

FIG. 14A is an image diagram illustrating specific examples of a part of the monitoring image video.

FIG. 14B is an image diagram illustrating other specific examples of a part of the monitoring image video.

FIG. 15 is an image diagram illustrating representative image video generated using monitoring image video for 50 seconds.

FIG. 16 is an image diagram illustrating a representative image generated using a first example of a method for generating a representative image.

FIG. 17 is an image diagram illustrating a representative image generated using a second example of the method for generating a representative image.

FIG. 18 is a schematic diagram illustrating a process of generating representative image video from monitoring image video according to a first variation of the embodiment.

FIG. 19 is a schematic diagram illustrating a process of generating representative image video from monitoring image video according to a second variation of the embodiment.

FIG. 20 is a block diagram illustrating a configuration of a gas detection system according to a third variation of the embodiment.

FIG. 21 is an explanatory diagram illustrating an exemplary method for converting a grayscale region into a colored region.

FIG. 22A is an image diagram illustrating specific examples of a visible image in which a colored gas region is combined.

FIG. 22B is an image diagram illustrating other specific examples of the visible image in which a colored gas region is combined.

FIG. 23 is a schematic diagram illustrating a process of generating representative image video from visible image video according to a third variation of the embodiment.

FIG. 24 is an image diagram illustrating representative image video generated using visible image video for 50 seconds.

FIG. 25 is an image diagram illustrating representative image generated according to a first mode of the third variation.

FIG. 26 is an image diagram illustrating representative image generated according to a second mode of the third variation.

### DESCRIPTION OF EMBODIMENTS

Hereinafter, one or more embodiments of the present invention will be described with reference to the accompanying drawings. However, the scope of the present invention is not limited to the disclosed embodiments.

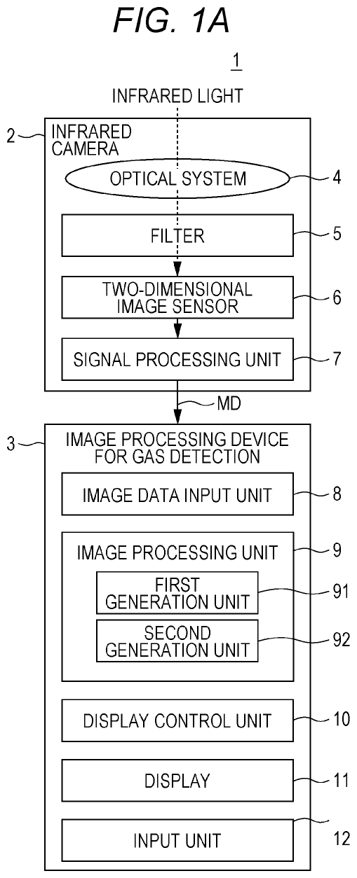

In each drawing, a configuration denoted by a same reference sign indicates a same configuration, and description of content of the configuration that has already described is omitted. FIG. 1A is a block diagram illustrating a configuration of a gas detection system 1 according to an embodiment. The gas detection system 1 includes an infrared camera 2, and an image processing device for gas detection 3.

The infrared camera 2 captures video of infrared images of a subject including a monitoring target of a gas leak (e.g., portion where gas transport pipes are connected with each other), and generates moving image data MD indicating the video. It only needs to be a plurality of infrared images captured in a time series, and is not limited to moving images. The infrared camera 2 includes an optical system 4, a filter 5, a two-dimensional image sensor 6, and a signal processing unit 7.

The optical system 4 forms an infrared image of a subject on the two-dimensional image sensor 6. The filter 5 is disposed between the optical system 4 and the two-dimensional image sensor 6, and transmits only infrared light of a specific wavelength among the light having passed through the optical system 4. The wavelength band to pass through the filter 5 among the infrared wavelength bands depends on a type of the gas to be detected. For example in the case of methane, a filter 5 that allows a wavelength band of 3.2 to 3.4 μm to pass therethrough is used. The two-dimensional image sensor 6 is, for example, a cooled indium antimony (InSb) image sensor, which receives infrared light having passed through the filter 5. The signal processing unit 7 converts analog signals output from the two-dimensional image sensor 6 into digital signals, and performs publicly known image processing. Those digital signals become the moving image data MD.

The image processing device for gas detection 3 is a personal computer, a smartphone, a tablet terminal, or the like, and includes an image data input unit 8, an image processing unit 9, a display control unit 10, a display 11, and an input unit 12 as functional blocks.

The image data input unit 8 is a communication interface that communicates with a communication unit (not illustrated) of the infrared camera 2. The moving image data MD transmitted from the communication unit of the infrared camera 2 is input to the image data input unit 8. The image data input unit 8 transmits the moving image data MD to the image processing unit 9.

The image processing unit 9 performs predetermine processing on the moving image data MD. The predetermined processing is, for example, processing of generating time-series pixel data from the moving image data MD.

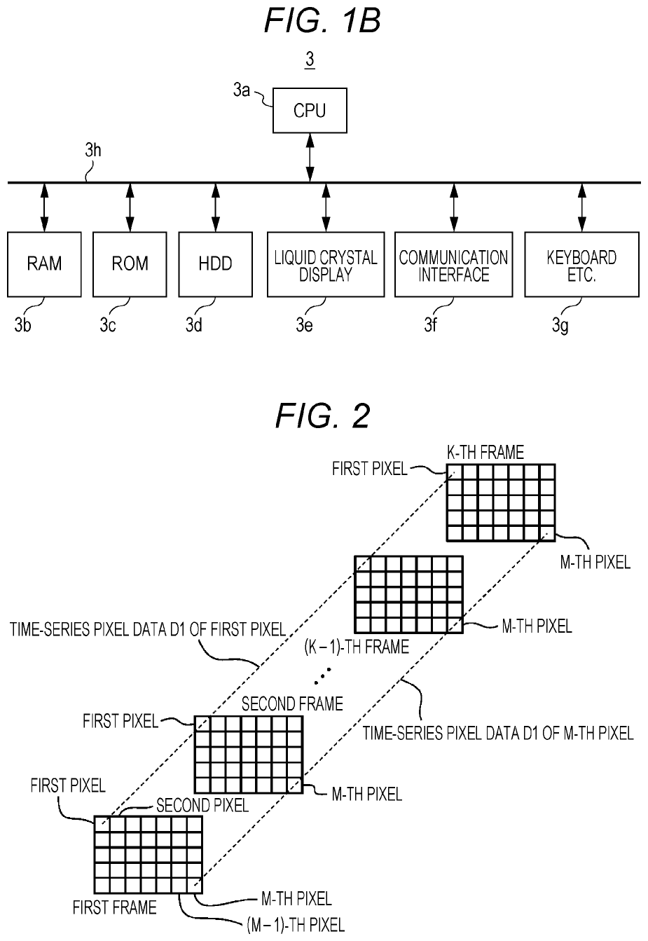

The time-series pixel data will be specifically described. FIG. 2 is an explanatory diagram illustrating time-series pixel data D1. A moving image indicated by the moving image data MD has a structure in which a plurality of frames is arranged in a time series. Data obtained by arranging pixel data of pixels at the same position in a time series in a plurality of frames (a plurality of infrared images) is referred to as time-series pixel data D1. The number of frames of video of the infrared images is assumed to be K. One frame includes pixels of the number of M, that is, a first pixel, a second pixel, . . . , an (M−1)-th pixel, and an M-th pixel. Physical quantities such as luminance and temperature are determined on the basis of pixel data (pixel values).

The pixels at the same position in the plurality (K) of frames indicate pixels in the same order. For example, in the case of the first pixel, data obtained by arranging, in a time series, pixel data of the first pixel included in the first frame, pixel data of the first pixel included in the second frame, . . . , pixel data of the first pixel included in the (K−1)-th frame, and pixel data of the first pixel included in the K-th frame is to be the time-series pixel data D1 of the first pixel. Furthermore, in the case of the M-th pixel, data obtained by arranging, in a time series, pixel data of the M-th pixel included in the first frame, pixel data of the M-th pixel included in the second frame, . . . , pixel data of the M-th pixel included in the (K−1)-th frame, and pixel data of the M-th pixel included in the K-th frame is to be the time-series pixel data D1 of the M-th pixel. The number of the time-series pixel data D1 is the same as the number of pixels included in one frame.

Referring to FIG. 1A, the image processing unit 9 includes a first generation unit 91, and a second generation unit 92. Those will be described later.

The display control unit 10 causes the display 11 to display the moving image indicated by the moving image data MD and the moving image on which the predetermined processing mentioned above is performed by the image processing unit 9.

The input unit 12 receives various kinds of input related to gas detection. Although the image processing device for gas detection 3 according to the embodiment includes the display 11 and the input unit 12, the image processing device for gas detection 3 may not include those units.

FIG. 1B is a block diagram illustrating a hardware configuration of the image processing device for gas detection 3 illustrated in FIG. 1A. The image processing device for gas detection 3 includes a central processing unit (CPU) 3a, a random access memory (RAM) 3b, a read only memory (ROM) 3c, a hard disk drive (HDD) 3d, a liquid crystal display 3e, a communication interface 3f, a keyboard etc. 3g, and a bus 3h connecting those components. The liquid crystal display 3e is hardware that implements the display 11. Instead of the liquid crystal display 3e, an organic light-emitting (EL) diode display, a plasma display, or the like may be used. The communication interface 3f is hardware that implements the image data input unit 8. The keyboard etc. 3g is hardware that implements the input unit 12. Instead of the keyboard, a touch panel may be used.

The HDD 3d stores programs for implementing the functional blocks of the image processing unit 9 and the display control unit 10, and various kinds of data (e.g., moving image data MD). The program for implementing the image processing unit 9 is a processing program for obtaining the moving image data MD and performing the predetermined processing mentioned above on the moving image data MD. The program for implementing the display control unit 10 is, for example, a display control program for displaying a moving image indicated by the moving image data MD on the display 11 or displaying a moving image having been subject to the predetermined processing mentioned above performed by the image processing unit 9 on the display 11. Although those programs are stored in advance in the HDD 3d, they are not limited thereto. For example, a recording medium (e.g., external recording medium such as a magnetic disk and an optical disk) recording those programs may be prepared, and the programs recorded in the recording medium may be stored in the HDD 3d. In addition, those programs may be stored in a server connected to the image processing device for gas detection 3 via a network, and those programs may be transmitted to, via the network, the HDD 3d to be stored in the HDD 3d. Those programs may be stored in the ROM 3c instead of the HDD 3d. The image processing device for gas detection 3 may include a flash memory instead of the HDD 3d, and those programs may be stored in the flash memory.

The CPU 3a is an exemplary hardware processor, which reads out those programs from the HDD 3d, loads them in the RAM 3b, and executes the loaded programs, thereby implementing the image processing unit 9 and the display control unit 10. However, a part of or all of respective functions of the image processing unit 9 and the display control unit 10 may be implemented by processing performed by a digital signal processor (DSP) instead of or together with processing performed by the CPU 3a. Likewise, a part of or all of the respective functions may be implemented by processing performed by a dedicated hardware circuit instead of or together with processing performed by software.

Note that the image processing unit 9 includes a plurality of components illustrated in FIG. 1A. Accordingly, the HDD 3d stores programs for implementing those components. That is, the HDD 3d stores programs for implementing the respective first generation unit 91 and second generation unit 92. Those programs are expressed as a first generation program and a second generation program. The HDD storing the first generation program may be different from the HDD storing the second generation program. In that case, a server including the HDD storing the first generation program and a server including the HDD storing the second generation program may be connected to each other via a network (e.g., the Internet). Alternatively, at least one of the HDDs may be an external HDD connected to a USB port or the like, or may be an HDD (network attached storage (NAS)) that is network-compatible.

Those programs are expressed using definitions of the components. The first generation unit 91 and the first generation program will be described as an example. The first generation unit 91 obtains first time-series images whose imaging time is a first predetermined time period, sets a plurality of second predetermined time periods arranged in a time series and included in the first predetermined time period, and generates, for second time-series images respectively corresponding to the plurality of second predetermined time periods, a representative image of the second time-series images corresponding to the second predetermined time period and to a part of the first time-series images, thereby generating time-series representative images. The first generation program is a program that obtains first time-series images whose imaging time is a first predetermined time period, sets a plurality of second predetermined time periods arranged in a time series and included in the first predetermined time period, and generates, for second time-series images respectively corresponding to the plurality of second predetermined time periods, a representative image of the second time-series image corresponding to the second predetermined time period and to a part of the first time-series images, thereby generating time-series representative images.

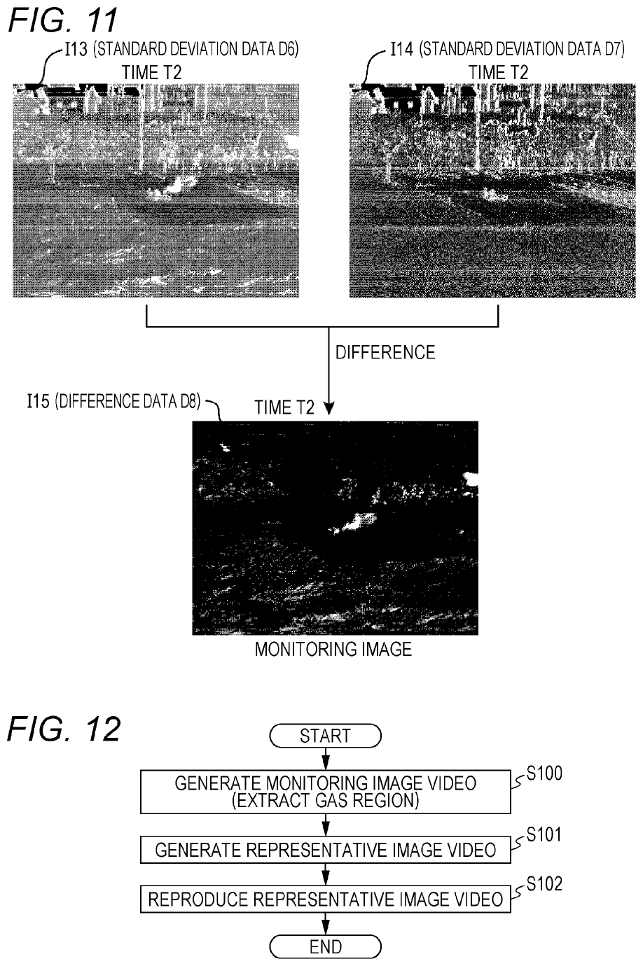

A flowchart of those programs (first generation program, second generation program, etc.) to be executed by the CPU 3a is illustrated in FIG. 12 to be described later.

The present inventor has found out that, in gas detection using an infrared image, in a case where a gas leak and a background temperature change occur in parallel and the background temperature change is larger than the temperature change due to the leaked gas, it is not possible to display an image of leaking gas unless the background temperature change is considered. This will be described in detail.

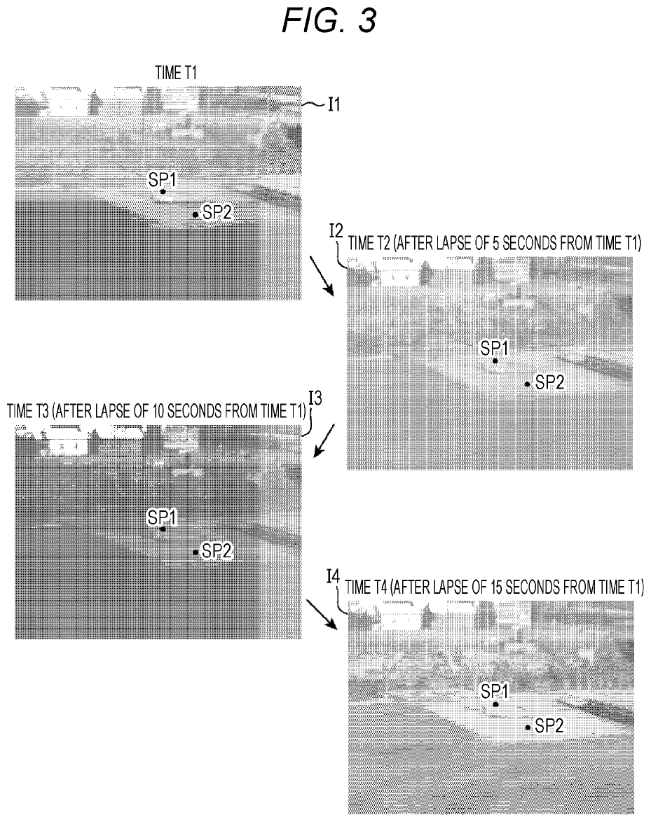

FIG. 3 is an image diagram illustrating, in a time series, infrared images of an outdoor test site captured while a gas leak and a background temperature change are occurring in parallel. Those are infrared images obtained by capturing a moving image with an infrared camera. In the test site, there is a spot SP1 at which gas can be ejected. In order to compare with the spot SP1, a spot SP2 at which no gas is ejected is illustrated.

An image I1 is an infrared image of the test site captured at time T1 immediately before the sunlight is obstructed by clouds. An image I2 is an infrared image of the test site captured at time T2 5 seconds after the time T1. Since the sunlight is obstructed by clouds at the time T2, the background temperature is lower than that at the time T1.

An image I3 is an infrared image of the test site captured at time T3 10 seconds after the time T1. Since the state in which the sunlight is obstructed by clouds continues from the time T2 to the time T3, the background temperature at the time T3 is lower than that at the time T2.

An image I4 is an infrared image of the test site captured at time T4 15 seconds after the time T1. Since the state in which the sunlight is obstructed by clouds continues from the time T3 to the time T4, the background temperature at the time T4 is lower than that at the time T3.

The background temperature has dropped by about 4° C. in 15 seconds from the time T1 to the time T4. Therefore, it can be seen that the image I4 is overall darker than the image I1, and the background temperature is lower.

At a time after the time T1 and before the time T2, gas ejection starts at the spot SP1. The temperature change due to the ejected gas is slight (about 0.5° C.). Therefore, while the gas is ejected at the spot SP1 at the time T2, the time T3, and the time T4, the background temperature change is much larger than the temperature change due to the ejected gas, whereby it cannot be understood that the gas is ejected at the spot SP1 by viewing the image I2, the image I3, and the image I4.

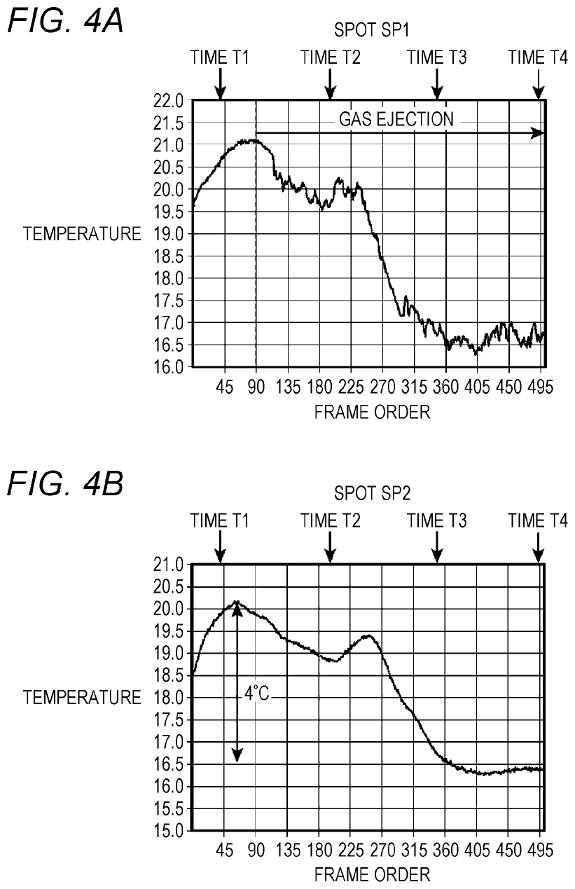

FIG. 4A is a graph illustrating a temperature change at the spot SP1 in the test site, and FIG. 4B is a graph illustrating a temperature change at the spot SP2 in the test site. The vertical axes of those graphs represent a temperature. The horizontal axes of those graphs represent an order of frames. For example, 45 indicates the 45th frame. A frame rate is 30 fps. Accordingly, time from the first frame to the 450th frame is 15 seconds.

The graph illustrating a temperature change at the spot SP1 is different from the graph illustrating a temperature change at the spot SP2. Since no gas is ejected at the spot SP2, the temperature change at the spot SP2 indicates a background temperature change. Meanwhile, since gas is ejected at the spot SP1, gas is drifting at the spot SP1. Therefore, the temperature change at the spot SP1 indicates a temperature change obtained by adding the background temperature change and the temperature change due to the leaked gas.

It can be seen from the graph illustrated in FIG. 4A that the gas is ejected at the spot SP1 (i.e., it can be seen that a gas leak occurs at the spot SP1). However, as described above, it cannot be seen from the image I2, the image I3, and the image I4 illustrated in FIG. 3 that the gas is ejected at the spot SP1 (i.e., it cannot be seen that a gas leak occurs at the spot SP1).

As described above, in a case where the background temperature change is much larger than the temperature change due to the ejected gas (leaked gas), it cannot be understood that the gas is ejected at the spot SP1 by viewing the image I2, the image I3, and the image I4 illustrated in FIG. 3.

The reason is that the moving image data MD (FIG. 1A) includes, in addition to frequency component data indicating the temperature change due to the leaked gas, low-frequency component data D2 having a frequency lower than that of the frequency component data and indicating the background temperature change. An image indicated by the low-frequency component data D2 (light-dark change of the background) makes an image indicated by the frequency component data disappear. Referring to FIGS. 4A and 4B, a minute change included in the graph illustrating a temperature change at the spot SP1 corresponds to the frequency component data mentioned above. The graph illustrating a temperature change at the spot SP2 corresponds to the low-frequency component data D2.

The image processing unit 9 (FIG. 1A) generates, from the moving image data MD, a plurality of time-series pixel data D1 (i.e., a plurality of time-series pixel data D1 included in the moving image data MD) having different pixel positions, and removes the low-frequency component data D2 from each of the plurality of time-series pixel data D1. Referring to FIG. 2, the plurality of time-series pixel data having different pixel positions indicates the time-series pixel data D1 of a first pixel, time-series pixel data D1 of a second pixel, . . . , the time-series pixel data D1 of an (M−1)-th pixel, and the time-series pixel data D1 of an M-th pixel.

The frequency component data having a frequency higher than the frequency of the frequency component data indicating the temperature change due to the leaked gas and indicating high-frequency noise is regarded as high-frequency component data D3. The image processing unit 9 performs, in addition to processing of removing the low-frequency component data D2, processing of removing the high-frequency component data D3 on each of the plurality of time-series pixel data D1 included in the moving image data MD.

In this manner, the image processing unit 9 does not perform processing of removing the low-frequency component data D2 and the high-frequency component data D3 in units of frames, but performs processing of removing the low-frequency component data D2 and the high-frequency component data D3 in units of time-series pixel data D1.

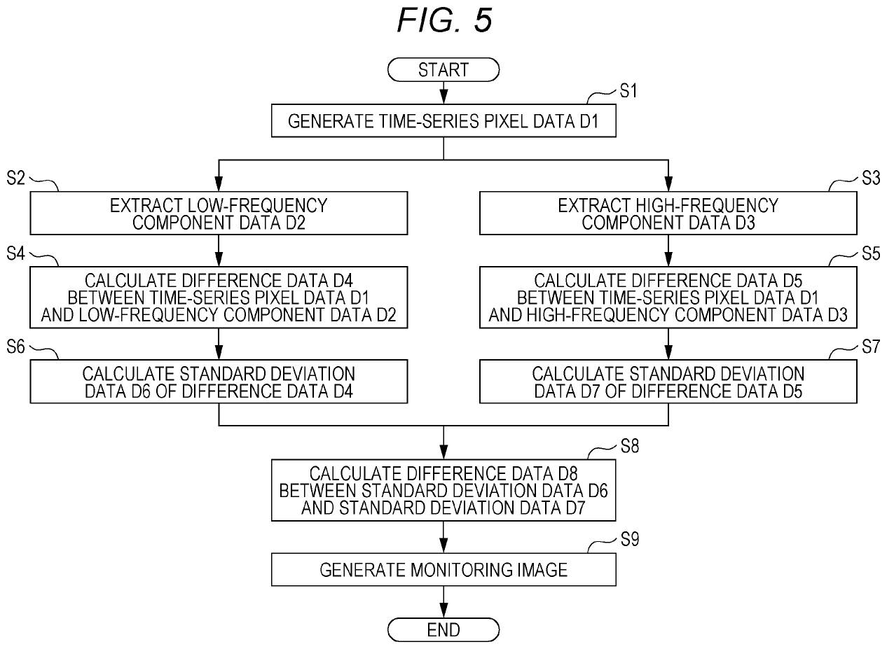

The image processing device for gas detection 3 generates a monitoring image using an infrared image. When a gas leak occurs, the monitoring image includes an image showing an area in which gas appears due to the gas leak. The image processing device for gas detection 3 detects the gas leak on the basis of the monitoring image. While various methods are available as a method of generating a monitoring image, an exemplary method of generating a monitoring image will be described here. The monitoring image is generated using infrared images of a monitoring target and the background. FIG. 5 is a flowchart illustrating a process of generating a monitoring image.

Referring to FIGS. 1A, 2, and 5, the image processing unit 9 generates M pieces of time-series pixel data D1 from the moving image data MD (step S1).

The image processing unit 9 sets data extracted from the time-series pixel data D1 by calculating a simple moving average in units of a first predetermined number of frames smaller than K frames for the time-series pixel data D1 as the low-frequency component data D2, and extracts M pieces of low-frequency component data D2 corresponding to the respective M pieces of time-series pixel data D1 (step S2).

The first predetermined number of frames is, for example, 21 frames. A breakdown thereof includes a target frame, consecutive 10 frames before the target frame, and consecutive 10 frames after the target frame. The first predetermined number only needs to be a number capable of extracting the low-frequency component data D2 from the time-series pixel data D1, and may be more than 21 or less than 21, not being limited to 21.

The image processing unit 9 sets data extracted from the time-series pixel data D1 by calculating a simple moving average in units of a third predetermined number (e.g., 3) of frames smaller than the first predetermined number (e.g., 21) for the time-series pixel data D1 as the high-frequency component data D3, and extracts M pieces of high-frequency component data D3 corresponding to the respective M pieces of time-series pixel data D1 (step S3).

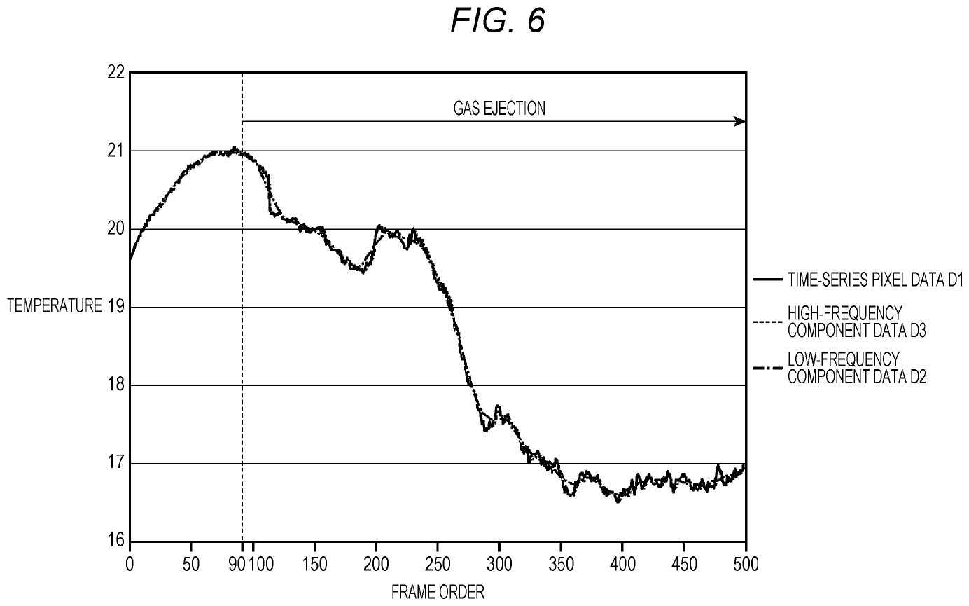

FIG. 6 is a graph illustrating the time-series pixel data D1 of a pixel corresponding to the spot SP1 (FIG. 4A), the low-frequency component data D2 extracted from the time-series pixel data D1, and the high-frequency component data D3 extracted from the time-series pixel data D1. The vertical and horizontal axes of the graph are the same as the vertical and horizontal axes of the graph of FIG. 4A. The temperature indicated by the time-series pixel data D1 changes relatively sharply (a period of a change is relatively short), and the temperature indicated by the low-frequency component data D2 changes relatively gradually (a period of a change is relatively long). The high-frequency component data D3 appears to substantially overlap with the time-series pixel data D1.

The third predetermined number of frames is, for example, three frames. A breakdown thereof includes a target frame, one frame immediately before the target frame, and one frame immediately after the target frame. The third predetermined number only needs to be a number capable of extracting a third frequency component from the time-series pixel data, and may be more than three, not being limited to three.

Referring to FIGS. 1A, 2, and 5, the image processing unit 9 sets data obtained by calculating a difference between the time-series pixel data D1 and the low-frequency component data D2 extracted from the time-series pixel data D1 as difference data D4, and calculates M pieces of difference data D4 corresponding to the respective M pieces of time-series pixel data D1 (step S4).

The image processing unit 9 sets data obtained by calculating a difference between the time-series pixel data D1 and the high-frequency component data D3 extracted from the time-series pixel data D1 as difference data D5, and calculates M pieces of difference data D5 corresponding to the respective M pieces of time-series pixel data D1 (step S5).

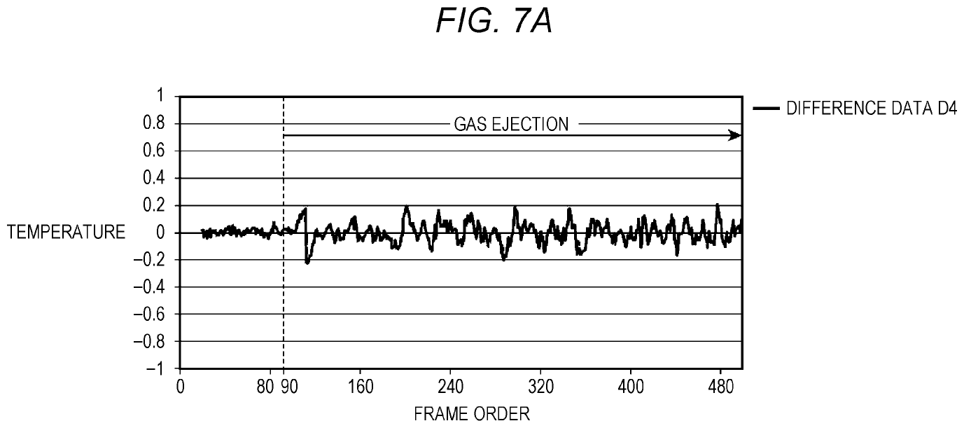

FIG. 7A is a graph illustrating the difference data D4, and FIG. 7B is a graph illustrating the difference data D5. The vertical and horizontal axes of those graphs are the same as the vertical and horizontal axes of the graph of FIG. 4A. The difference data D4 is data obtained by calculating a difference between the time-series pixel data D1 and the low-frequency component data D2 illustrated in FIG. 6. Before the start of the gas ejection at the spot SP1 illustrated in FIG. 4A (up to around the 90th frame), the repetition of the minute amplitude indicated by the difference data D4 mainly indicates sensor noise of the two-dimensional image sensor 6. After the start of the gas ejection at the spot SP1 (90th and subsequent frames), variation in the amplitude and waveform of the difference data D4 becomes larger.

The difference data D5 is data obtained by calculating a difference between the time-series pixel data D1 and the high-frequency component data D3 illustrated in FIG. 6.

The difference data D4 includes frequency component data indicating a temperature change due to the leaked gas, and the high-frequency component data D3 (data indicating high-frequency noise). The difference data D5 does not include frequency component data indicating a temperature change due to the leaked gas, and includes the high-frequency component data D3.

Since the difference data D4 includes the frequency component data indicating a temperature change due to the leaked gas, the variation in the amplitude and waveform of the difference data D4 becomes larger after the start of the gas ejection at the spot SP1 (90th and subsequent frames). On the other hand, since the difference data D5 does not include the frequency component data indicating a temperature change due to the leaked gas, such a situation does not occur. The difference data D5 repeats a minute amplitude. This is the high-frequency noise.

Although the difference data D4 and the difference data D5 are correlated with each other, they are not completely correlated with each other. That is, in a certain frame, a value of the difference data D4 may be positive and a value of the difference data D5 may be negative or vice versa. Therefore, even if a difference between the difference data D4 and the difference data D5 is calculated, the high-frequency component data D3 cannot be removed. In order to remove the high-frequency component data D3, it is necessary to convert the difference data D4 and the difference data D5 into values such as absolute values that can be subject to subtraction.

In view of the above, the image processing unit 9 sets data obtained by calculating moving standard deviation in units of a second predetermined number of frames smaller than the K frames for the difference data D4 as standard deviation data D6, and calculates M pieces of standard deviation data D6 corresponding to the respective M pieces of time-series pixel data D1 (step S6). Note that moving variance may be calculated instead of the moving standard deviation.

Further, the image processing unit 9 sets data obtained by calculating moving standard deviation in units of a fourth predetermined number of frames smaller than the K frames (e.g., 21) for the difference data D5 as standard deviation data D7, and calculates M pieces of standard deviation data D7 corresponding to the respective M pieces of time-series pixel data D1 (step S7). Moving variance may be used instead of the moving standard deviation.

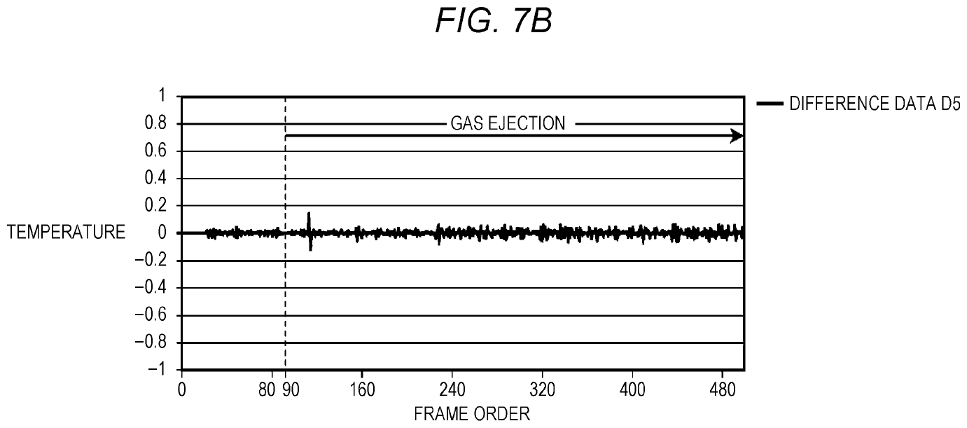

FIG. 8 is a graph illustrating the standard deviation data D6 and the standard deviation data D7. The horizontal axis of the graph is the same as the horizontal axis of the graph of FIG. 4A. The vertical axis of the graph represents standard deviation. The standard deviation data D6 is data indicating moving standard deviation of the difference data D4 illustrated in FIG. 7A. The standard deviation data D7 is data indicating moving standard deviation of the difference data D5 illustrated in FIG. 7B. Although the number of frames to be used in calculating the moving standard deviation is 21 for both of the standard deviation data D6 and the standard deviation data D7, it only needs to be a number capable of obtaining statistically significant standard deviation, and is not limited to 21.

Since the standard deviation data D6 and the standard deviation data D7 are standard deviation, they do not include negative values. Therefore, the standard deviation data D6 and the standard deviation data D7 can be regarded as data obtained by converting the difference data D4 and the difference data D5 such that they can be subject to subtraction.

The image processing unit 9 sets data obtained by calculating a difference between the standard deviation data D6 and the standard deviation data D7 obtained from the same time-series pixel data D1 as difference data D8, and calculates M pieces of difference data D8 corresponding to the respective M pieces of time-series pixel data D1 (step S8).

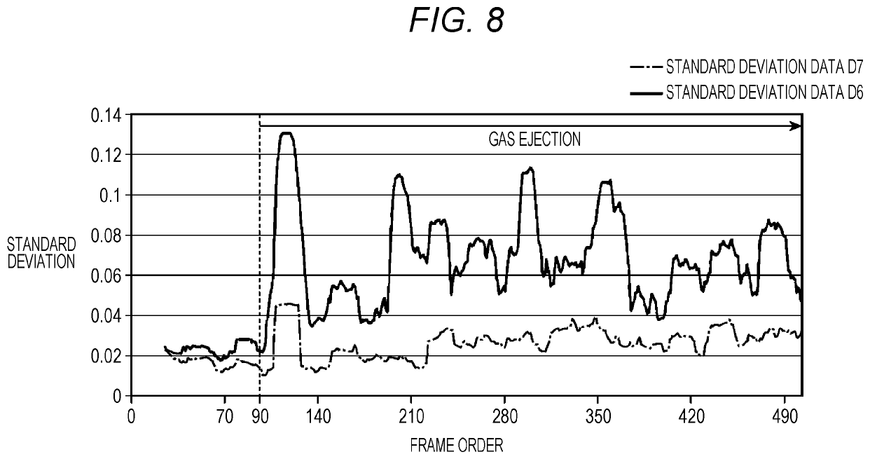

FIG. 9 is a graph illustrating the difference data D8. The horizontal axis of the graph is the same as the horizontal axis of the graph of FIG. 4A. The vertical axis of the graph represents difference of the standard deviation. The difference data D8 is data indicating difference between the standard deviation data D6 and the standard deviation data D7 illustrated in FIG. 8. The difference data D8 is data having been subject to a process of removing the low-frequency component data D2 and the high-frequency component data D3.

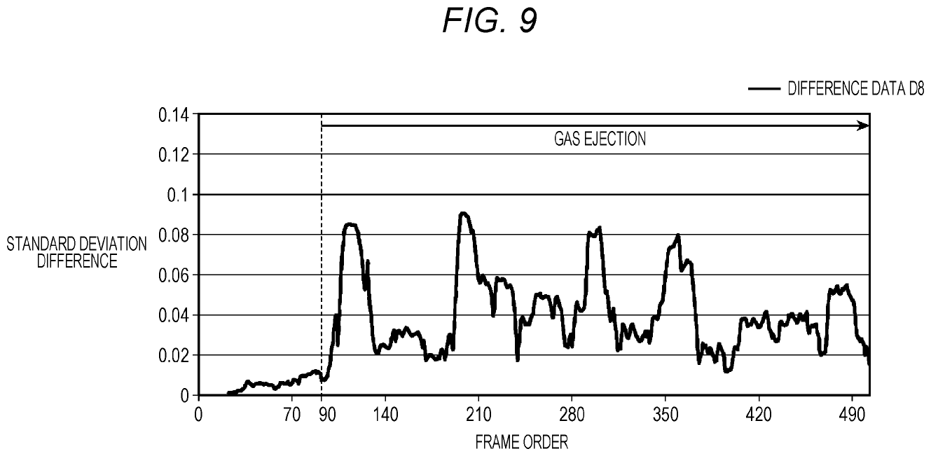

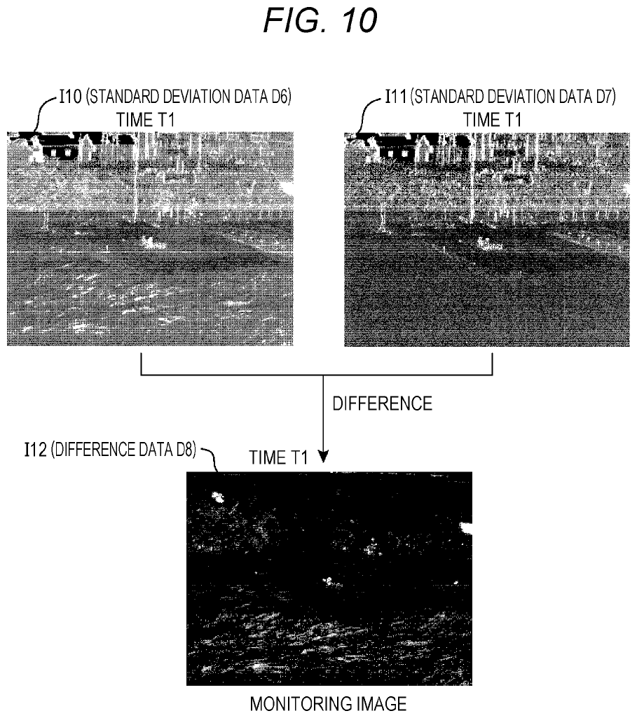

The image processing unit 9 generates a monitoring image (step S9). That is, the image processing unit 9 generates a video including the M pieces of difference data D8 obtained in step S8. Each frame included in the video is a monitoring image. The monitoring image is an image obtained by visualizing the difference of the standard deviation. The image processing unit 9 outputs the video obtained in step S9 to the display control unit 10. The display control unit 10 displays the video on the display 11. Examples of the monitoring image included in the video include an image I12 illustrated in FIG. 10, and an image I15 illustrated in FIG. 11.

FIG. 10 is an image diagram illustrating an image I10, an image I11, and an image I12 generated on the basis of a frame at the time T1. The image I10 is an image of the frame at the time T1 in the video indicated by the M pieces of standard deviation data D6 obtained in step S6 of FIG. 5. The image I1l is an image of the frame at the time T1 in the video indicated by the M pieces of standard deviation data D7 obtained in step S7 of FIG. 5. The difference between the image I10 and the image I11 is the image I12 (monitoring image).

FIG. 11 is an image diagram illustrating an image I13, an image I14, and an image I15 generated on the basis of a frame at the time T2. The image I13 is an image of the frame at the time T2 in the video indicated by the M pieces of standard deviation data D6 obtained in step S6. The image I14 is an image of the frame at the time T2 in the video indicated by the M pieces of standard deviation data D7 obtained in step S7. The difference between the image I13 and the image I14 is the image I15 (monitoring image). Each of the images I10 to I15 illustrated in FIGS. 10 and 11 is an image obtained by multiplying the standard deviation by 5,000.

Since the image I12 illustrated in FIG. 10 is an image captured before the gas is ejected at the spot SP1 illustrated in FIG. 4A, the image I12 does not show the state of gas being ejected at the spot SP1. On the other hand, the image I15 illustrated in FIG. 11 shows the state of gas being ejected at the spot SP1 as the image I15 is an image captured at the time when the gas is ejected at the spot SP1.

As described above, according to the embodiment, the image processing unit 9 (FIG. 1A) performs the process of removing the low-frequency component data D2 included in the moving image data MD of the infrared image to generate moving image data, and the display control unit 10 displays the moving image (video of the monitoring image) indicated by the moving image data on the display 11. Therefore, according to the embodiment, even in the case where a gas leak and a background temperature change occur in parallel and the background temperature change is larger than the temperature change due to the leaked gas, it is possible to display the state of the gas being leaked as a video of the monitoring image.

Sensor noise differs depending on a temperature as it becomes smaller as the temperature becomes higher. In the two-dimensional image sensor 6 (FIG. 1A), noise corresponding to the temperature sensed by the pixel is generated in each pixel. That is, the noise of all pixels is not the same. According to the embodiment, the high-frequency noise can be removed from the video, whereby it becomes possible to display even a slight gas leak on the display 11.

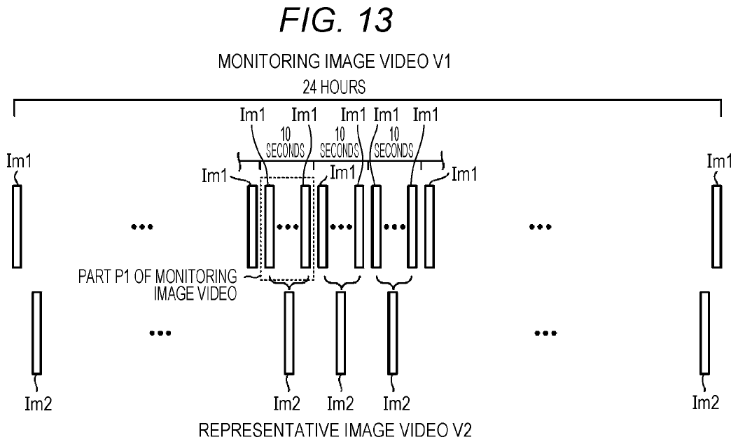

According to the embodiment, steps S100 to S102 illustrated in FIG. 12 are executed, whereby the user can grasp the contents of the time-series image in a short time without missing the gas region included in the image. FIG. 12 is a flowchart illustrating various processes to be executed in the embodiment to achieve this. FIG. 13 is a schematic diagram illustrating a process of generating representative image video V2 from monitoring image video V1 according to the embodiment.

Referring to FIGS. 1A and 13, the second generation unit 92 generates the monitoring image video V1 using the moving image data MD (step S100 in FIG. 12). More specifically, the second generation unit 92 obtains the moving image data MD input to the image data input unit 8. As described above, the moving image data MD (exemplary third time-series image) is a video of the gas monitoring target imaged by the infrared camera 2. As illustrated in FIG. 2, the video includes a plurality of infrared images arranged in a time series (first to K-th frames).

The second generation unit 92 performs a process of steps S1 to S9 illustrated in FIG. 5 (image processing of extracting a gas region) on the moving image data MD. Accordingly, each frame included in the video becomes a monitoring image Im1 from the infrared image, thereby generating the monitoring image video V1. The monitoring image video V1 (exemplary first time-series image) includes a plurality of monitoring images Im1 arranged in a time series.

The monitoring image Im1 is, for example, the image I12 illustrated in FIG. 10, or the image I15 illustrated in FIG. 11. The monitoring image video V1 includes a gas region during the period in which the gas to be detected appears or during the period in which the event causing misdetection occurs. The monitoring image video V1 does not include the gas region during the period in which the gas to be detected does not appear and the event causing the misdetection does not occur. Since the image I15 illustrated in FIG. 11 is an image captured at the time when the gas is ejected at the spot SP1, the gas region is near the spot SP1. The gas region is a region having relatively high luminance, which extends near the center of the image I15.

Although the gas region is extracted in the process of steps S1 to S9 illustrated in FIG. 5 in the embodiment, other image processing (e.g., image processing disclosed in Patent Literature 1) may be used as long as the image processing is for extracting the gas region from the infrared image.

Referring to FIGS. 1A and 13, the first generation unit 91 generates the representative image video V2 using the monitoring image video V1 (step S101 in FIG. 12). More specifically, the image processing unit 9 performs a process of removing noise (e.g., morphology) on each of the plurality of monitoring images Im1 included in the monitoring image video V1, and then determines whether or not the gas region is included in the monitoring image video V1 in real time. When there is the monitoring image Im1 including the gas region, the image processing unit 9 determines that the monitoring image video V1 includes the gas region.

When the image processing unit 9 determines that the monitoring image video V1 includes the gas region, the image processing device for gas detection 3 makes predetermined notification, thereby notifying the user of the gas detection. When the user determines that the detection may be misdetection, the user operates the input unit 12 to input the first predetermined time period and the second predetermined time period and to input a command to generate the representative image video V2. The first predetermined time period is a period that goes back from the time point at which the gas is detected. The second predetermined time period is a time unit of the monitoring image video V1 to be used for generating a representative image Im2. Here, it is assumed that the first predetermined time period is 24 hours, and the second predetermined time period is 10 seconds. Those are specific examples, and the first predetermined time period and the second predetermined time period are not limited to those values.

The first generation unit 91 obtains, from among the monitoring image videos V1 stored in the second generation unit 92, the monitoring image video V1 up to 24 hours before the time point at which the image processing device for gas detection 3 detects the gas, and divides the 24 hours of the obtained monitoring image video V1 into 10-second intervals. Each 10 seconds corresponds to a part P1 (exemplary second time-series image) of the monitoring image video V1. The part P1 of the monitoring image video V1 includes a plurality of monitoring images Im1 arranged in a time series.

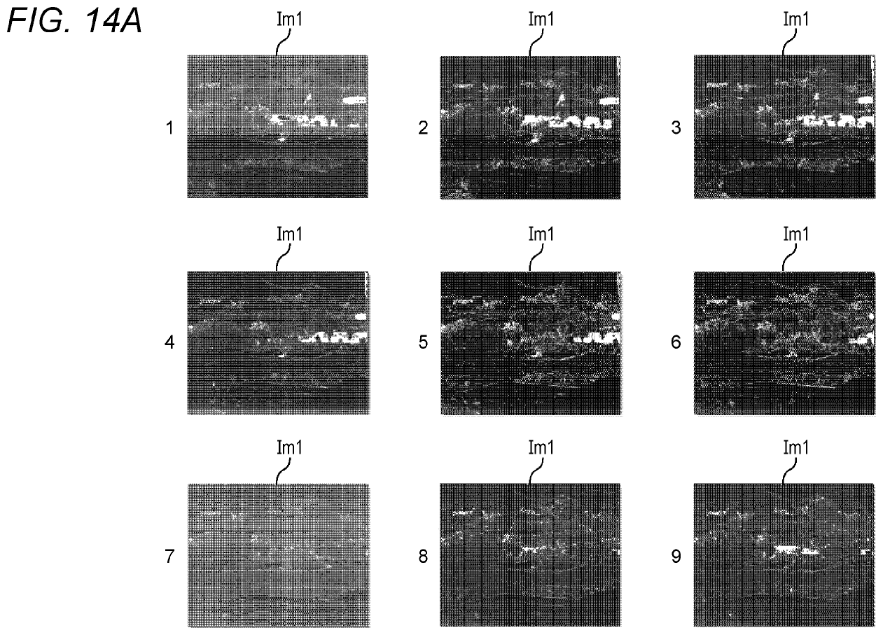

FIGS. 14A and 14B are image diagrams illustrating specific examples of the part P1 of the monitoring image video V1. The part P1 of the monitoring image video V1 includes 300 monitoring images Im1 (frames) arranged in a time series. FIGS. 14A and 14B illustrate examples in which a part of 300 sheets is sampled at approximately equal intervals. This corresponds to 10 seconds. The first monitoring image Im1 is sampled as a monitoring image Im1 at the start of 10 seconds. The 16th monitoring image Im1 is sampled as a monitoring image Im1 at the end of 10 seconds. The vicinity of the center of each monitoring image Im1 is the spot SP1 (FIG. 3). Within the 10 seconds, while first to fifth monitoring images Im1 and 15th to 16th monitoring images Im1 clearly show the gas region (although it may be difficult to see in the drawing, the gas region appears in the actual images), 6th to 14th monitoring images Im1 does not clearly show the gas region.

Referring to FIGS. 1A and 13, the first generation unit 91 generates a representative image Im2 for the part P1 of the monitoring image video V1 corresponding to each 10 seconds, thereby generating the representative image video V2 (exemplary time-series representative image). The representative image video V2 includes a plurality of representative images Im2 arranged in a time series. Since the representative image Im2 is created in units of 10 seconds, the number of the representative images Im2 (frames) included in the representative image video V2 is 8,640 (=24 hours×60 minutes×6).

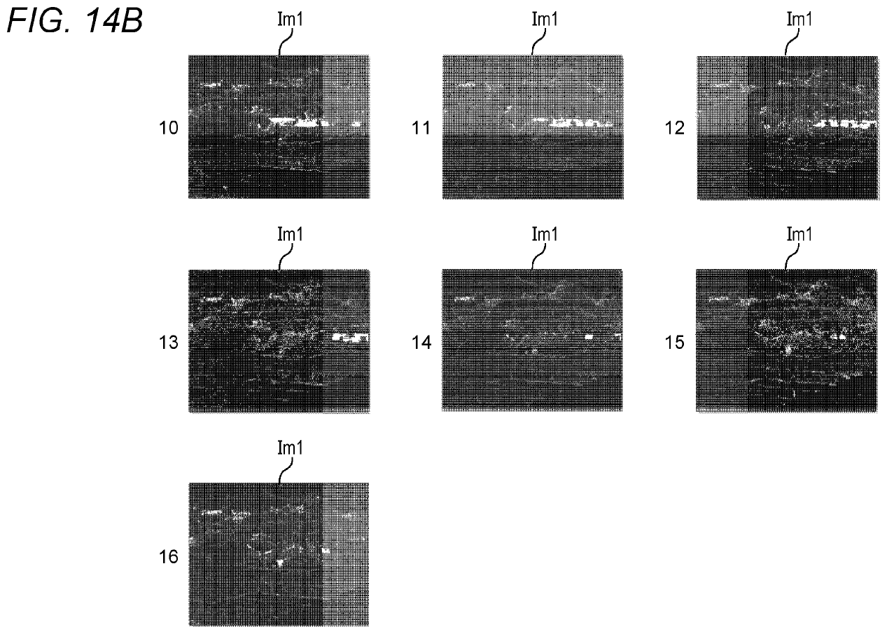

A specific example of the representative image video V2 is illustrated in FIG. 15. FIG. 15 is an image diagram illustrating the representative image video V2 generated using the monitoring image video V1 for 50 seconds. The image indicated by “11:48” is a representative image Im2 for 10 seconds from 11 minutes 48 seconds to 11 minutes 58 seconds. The image indicated by “11:58” is a representative image Im2 for 10 seconds from 11 minutes 58 seconds to 12 minutes 08 seconds. The image indicated by “12:08” is a representative image Im2 for 10 seconds from 12 minutes 08 seconds to 12 minutes 18 seconds. The image indicated by “12:18” is a representative image Im2 for 10 seconds from 12 minutes 18 seconds to 12 minutes 28 seconds. The image indicated by “12:28” is a representative image Im2 for 10 seconds from 12 minutes 28 seconds to 12 minutes 38 seconds.

In order to suppress oversight of the gas region, if the gas region is present in at least a part of 10 seconds, the first generation unit 91 causes the representative image Im2 to include the gas region. A first exemplary method of generating the representative image Im2 will be described. Referring to FIGS. 1A and 13, the first generation unit 91 determines, from among pixels positioned in the same order in the plurality of monitoring images Im1 included in the part P1 (second time-series images) of the monitoring image video V1, a maximum value of the value indicated by the pixels (in this case, a difference of the standard deviation). The first generation unit 91 sets the maximum value as a value of the pixel positioned in the above order in the representative image Im2. More specifically, the first generation unit 91 determines a maximum value of a value indicated by the first pixel in the plurality of monitoring images Im1 included in the part P1 of the monitoring image video V1, and sets the value as a value of the first pixel of the representative image Im2. The first generation unit 91 determines a maximum value of a value indicated by the second pixel in the plurality of monitoring images Im1 included in the part P1 of the monitoring image video V1, and sets the value as a value of the second pixel of the representative image Im2. The first generation unit 91 performs similar processing for the third and subsequent pixels.

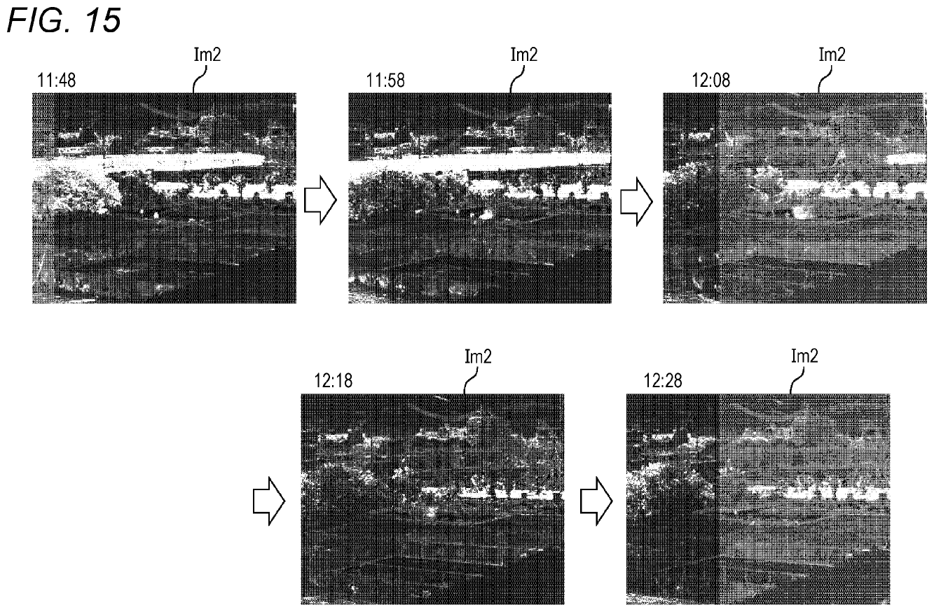

FIG. 16 is an image diagram illustrating the representative image Im2 generated using the first exemplary method of generating the representative image Im2. A region with high luminance extends relatively largely in the vicinity of the center of the representative image Im2 (spot SP1 in FIG. 3). This is the gas region. Since the values indicated by the pixels included in the gas region are relatively large, the region including the pixels having relatively large values is the gas region. In the first example, the representative image Im2 is generated without determining whether or not the gas region is included in the part P1 (second time-series images) of the monitoring image video V1. According to the first example, in a case where the gas region is included in the part P1 of the monitoring image video V1, the gas region included in the representative image Im2 is to be a gas region indicating a logical sum of the gas regions included in the respective monitoring images Im1 included in the part P1 of the monitoring image video V1. Therefore, it has been found out that, in a case where the gas fluctuates due to a change in the wind direction or the like, the area of the gas region included in the representative image Im2 can be enlarged. In such a case, the user can easily find the gas region.

A second exemplary method of generating the representative image Im2 will be described. Referring to FIGS. 1A and 13, the first generation unit 91 performs a process of removing noise (e.g., morphology) on each of the plurality of monitoring images Im1 included in the part P1 (second time-series images) of the monitoring image video V1, and then determines whether or not the gas region is included in each of the plurality of monitoring images Im1. In a case where at least one of the plurality of monitoring images Im1 includes the gas region, the first generation unit 91 determines that the part P1 of the monitoring image video V1 includes the gas region. In a case where the part P1 of the monitoring image video V1 includes the gas region, the first generation unit 91 calculates an average luminance value of the gas region for each of the monitoring images Im1 including the gas region among the plurality of monitoring images Im1 included in the part P1 of the monitoring image video V1. A method of calculating the average luminance value of the gas region will be briefly described. The first generation unit 91 cuts out the gas region from the monitoring image Im1, and calculates an average value of the luminance values of the pixels included in the gas region. This is the average luminance value of the gas region.

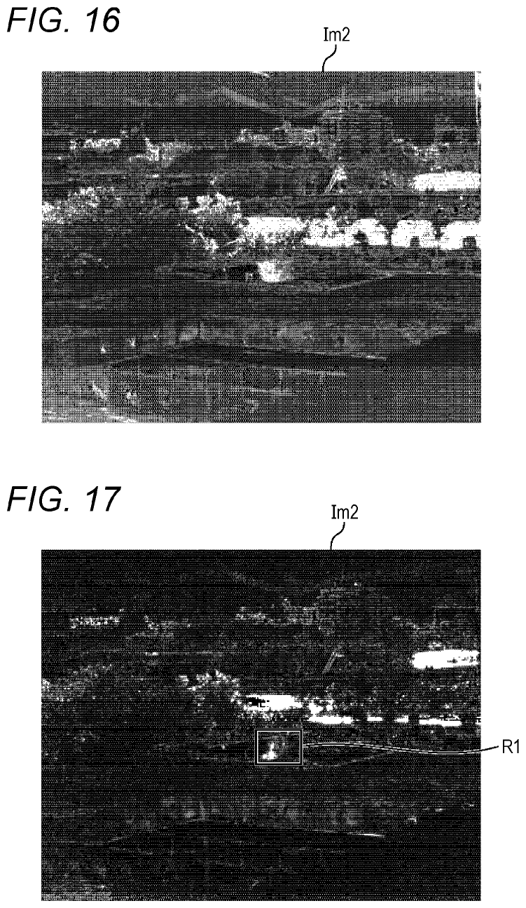

The first generation unit 91 selects the monitoring image Im1 having the maximum average luminance value of the gas region as a representative image Im2. FIG. 17 is an image diagram illustrating the representative image Im2 generated using the second exemplary method of generating the representative image Im2. A rectangular region R1 in the vicinity of the center of the representative image Im2 (spot SP1 in FIG. 3) indicates a position of the gas region. The region with high luminance in the rectangular region R1 is the gas region. According to the second example, in a case where the part P1 (second time-series images) of the monitoring image video V1 includes the gas region, the average luminance value of the gas region included in the representative image Im2 can be increased. Accordingly, the user can easily find the gas region.

A third exemplary method of generating the representative image Im2 will be described. In the third example, an area of the gas region is used instead of the average luminance value of the gas region. Referring to FIGS. 1A and 13, the first generation unit 91 performs a process of removing noise (e.g., morphology) on each of the plurality of monitoring images Im1 included in the part P1 (second time-series images) of the monitoring image video V1, and then determines whether or not the gas region is included in each of the plurality of monitoring images Im1. In a case where at least one of the plurality of monitoring images Im1 includes the gas region, the first generation unit 91 determines that the part P1 of the monitoring image video V1 includes the gas region. In a case where the part P1 of the monitoring image video V1 includes the gas region, the first generation unit 91 calculates an area of the gas region for each of the monitoring images Im1 including the gas region among the plurality of monitoring images Im1 included in the part P1 of the monitoring image video V1. A method of calculating the area of the gas region will be briefly described. The first generation unit 91 cuts out a rectangular region surrounding the gas region from the monitoring image Im1, determines pixels with a certain value or more in the rectangle to be the gas region, and calculates the number of the pixels determined to be the gas region. This is to be the area of the gas region. The first generation unit 91 selects the monitoring image Im1 having the maximum area of the gas region as a representative image Im2.

According to the third example, in a case where the part P1 (second time-series images) of the monitoring image video V1 includes the gas region, the area of the gas region included in the representative image Im2 can be enlarged. Accordingly, the user can easily find the gas region.

In the second and third examples, the first generation unit 91 determines whether or not the part P1 of the monitoring image video V1 includes the gas region, and generates the representative image Im2 including the gas region in the case where the part P1 of the monitoring image video V1 includes the gas region. In the second and third examples, the first generation unit 91 determines that the part P1 of the monitoring image video V1 does not include the gas region in the case where any of the plurality of monitoring images Im1 included in the part P1 of the monitoring image video V1 does not include the gas region. In the case where the part P1 of the monitoring image video V1 does not include the gas region, the first generation unit 91 sets a predetermined monitoring image Im1 (optional monitoring image Im1) among the plurality of monitoring images Im1 included in the part P1 of the monitoring image video V1 as a representative image Im2. The predetermined monitoring image Im1 may be any one (e.g., the top monitoring image Im1) as long as it is a plurality of monitoring images Im1 included in the part P1 of the monitoring image video V1.

The user views the representative image video V2 (time-series representative images) to grasp the contents of the monitoring image video V1 (first time-series images) in a short time. In a case where there is a second predetermined time period in which no gas region is present in a plurality of the second predetermined time periods (10 seconds), it is necessary for the user to recognize the fact. In view of the above, in the case of the part P1 of the monitoring image video V1 corresponding to the second predetermined time period in which no gas region is present (in the case where no gas region is included in the part of the monitoring image video V1), the first generation unit 91 sets a predetermined monitoring image Im1 among the plurality of monitoring images Im1 included in the part P1 of the monitoring image video V1 as a representative image Im2.

As described above, the first generation unit 91 obtains the first time-series images (monitoring image video V1) whose imaging time is the first predetermined time period (24 hours), sets a plurality of the second predetermined time periods (10 seconds) arranged in a time series and included in the first predetermined time period, and generates, for the second time-series images respectively corresponding to the plurality of second predetermined time periods, a representative image Im2 of the second time-series images corresponding to the second predetermined time period and to a part of the first time-series images, thereby generating time-series representative images (representative image video V2).

Referring to FIGS. 1A and 13, the display control unit 10 reproduces the representative image video V2 (step S102 in FIG. 12). More specifically, when the representative image video V2 is generated, the image processing device for gas detection 3 notifies the user of the fact that the representative moving image can be reproduced. The user operates the input unit 12 to instruct reproduction of the representative image video V2. Accordingly, the display control unit 10 displays, on the display 11, a plurality of representative images Im2 included in the representative image video V2 in a time-series order (continuously displays the plurality of representative images Im2). A frame rate of the reproduction is assumed to be 4 fps, for example. A reproduction time is 36 minutes as expressed by the following formula. As described above, “8,640” is the number of representative images Im2 (frames) included in the representative image video V2.

8,640 frames÷4 fps=2,160 seconds=36 minutes

Note that the second predetermined time period is lengthened when it is desired to further shorten the reproduction time. For example, in the case where the second predetermined time period is 1 minute, the number of representative images Im2 (frames) included in the representative image video V2 is 1,440 (=24 hours×60 minutes). The reproduction time is 6 minutes as expressed by the following formula.

1,440 frames÷4 fps=360 seconds=6 minutes

In the case of generating the representative image Im2 using the first example described above, the maximum value of the pixel values during the second predetermined time period is set as the pixel value of the representative image Im2. Therefore, in this case, noise tends to be included in the representative image Im2 when the second predetermined time period is lengthened.

Referring to FIGS. 1A and 13, main operational effects of the embodiment will be described. The representative image Im2 is an image that represents the part P1 (second time-series images) of the monitoring image image. The representative image video V2 (time-series representative images) includes a plurality of representative images Im2 arranged in a time series. The display control unit 10 displays, on the display 11, the plurality of representative images Im2 in a time-series order. Therefore, the user can grasp the contents of the monitoring image video V1 (first time-series images) by viewing those representative images Im2.

In addition, since the representative image Im2 is an image that represents the part P1 of the monitoring image video V1, the number of the representative images Im2 included in the representative image video V2 is smaller than the number of the monitoring images Im1 included in the monitoring image video V1. Therefore, the reproduction time of the representative image video V2 can be made shorter than that of the monitoring image video V1.

In this manner, according to the embodiment, the user can grasp the contents of the time-series images (monitoring image video V1) in a short time.

In a case where the part P1 of the monitoring image video V1 includes the gas region, the first generation unit 91 generates a representative image Im2 including the gas region. Therefore, according to the embodiment, oversight of the gas region can be suppressed.

As described above, according to the embodiment, the user can grasp the contents of the monitoring image video V1 in a short time without missing the gas region included in the image. Therefore, effects similar to the effects obtained by digest reproduction of the monitoring image video V1 can be obtained.

A service is conceivable in which the gas detection system 1 is used to monitor a gas monitoring target (e.g., gas piping in a gas plant) for a long period of time and facts occurred during the period are provided to the user. If the representative image video V2 is stored in a cloud computing storage, a service provider is not required to visit the site where the gas monitoring target is located. In the case of using cloud computing, it is not realistic to continuously upload all the data of the monitoring image video V1 to the cloud from the viewpoint of data capacity and bandwidth, and it is preferable to reduce the data volume. As described above, since the number of the representative images Im2 included in the representative image video V2 is smaller than the number of the monitoring images Im1 included in the monitoring image video V1, the data volume of the representative image video V2 can be made smaller than that of the monitoring image video V1.

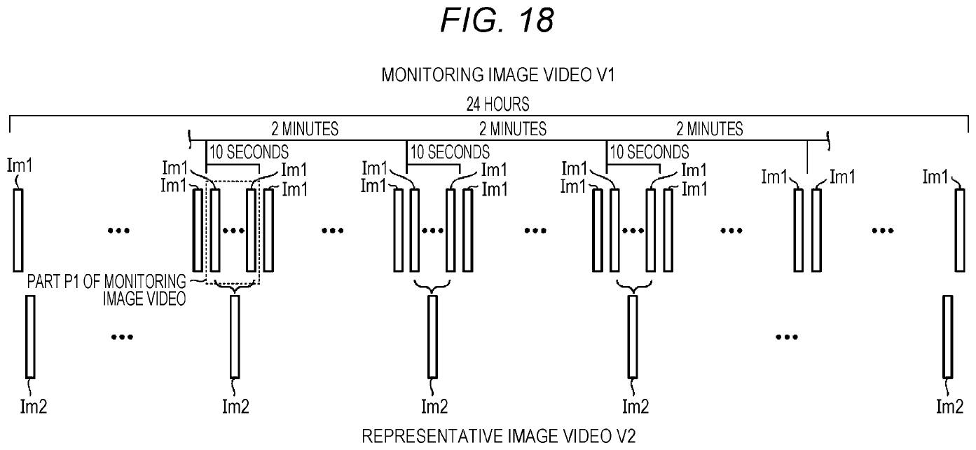

A first variation of the embodiment will be described. In the embodiment, as illustrated in FIG. 13, 24 hours (first predetermined time period) is divided into 10-second intervals, and each 10 seconds is set as a second predetermined time period. That is, in the embodiment, a plurality of second predetermined time periods is continuous. Meanwhile, according to the first variation, a plurality of second predetermined time periods is set at predetermined intervals. FIG. 18 is a schematic diagram illustrating a process of generating representative image video V2 from monitoring image video V1 according to the first variation of the embodiment.

Referring to FIGS. 1A and 18, in the first variation, a first generation unit 91 divides the monitoring image video V1 of 24 hours into 2-minute intervals, and sets the top 10 seconds within the 2 minutes as a second predetermined time period. In this manner, according to the first variation, the first generation unit 91 sets a plurality of divided periods (2 minutes) obtained by dividing the first predetermined time period (24 hours), and sets the second predetermined time period (10 seconds) included in the divided period and shorter than the divided period for each of the plurality of divided periods. Note that the 24 hours, 2 minutes, and 10 seconds are specific examples, and the first predetermined time period, the divided period, and the second predetermined time period are not limited to those values. In addition, although the second predetermined time period has been described as an example starting from the top (beginning) of the divided period, it may not be from the top.

In the first variation, the first generation unit 91 generates a representative image Im2 using a part P1 of the monitoring image video V1 corresponding to each 10 seconds. This is similar to the embodiment.

The total period of the plurality of divided periods (2 minutes) is the same length as the first predetermined time period (24 hours). According to the first variation, since the second predetermined time period (10 seconds) is shorter than the divided period, a plurality of second predetermined time periods is to be set at predetermined intervals. According to the first variation, the number of the representative images Im2 can be made smaller in the case where the second predetermined time period has the same length compared with the aspect in which the plurality of second predetermined time periods is set to be continuous (FIG. 13). Therefore, according to the first variation, even if the first predetermined time period is long, the contents of the monitoring image video V1 (first time-series images) can be roughly grasped without increasing the reproduction time of the representative image video V2 (time-series representative images). The first variation is effective in the case where the first predetermined time period is long (e.g., one day).

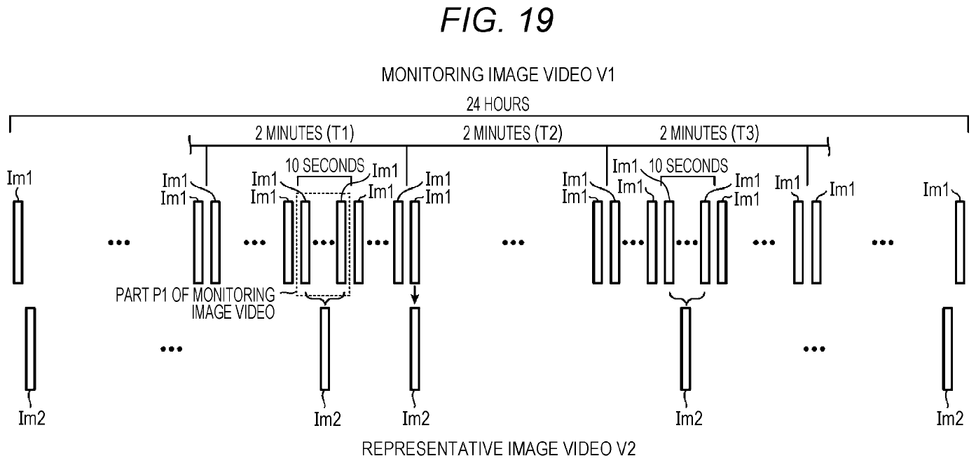

A second variation of the embodiment will be described. FIG. 19 is a schematic diagram illustrating a process of generating representative image video V2 from monitoring image video V1 according to the second variation of the embodiment. There may be a gas region in a part of divided periods (2 minutes) instead of the entire period thereof. As illustrated in FIG. 18, in the first variation, the top period (10 seconds) of the respective divided periods (2 minutes) is set to be a second predetermined time period. There may be a case where no gas region is generated in the top period and a gas region is generated in other than the top period. In such a case, the gas region is overlooked. As will be described below, according to the second variation, oversight of the gas region can be suppressed.

Referring to FIGS. 1A and 19, in the second variation, in a case where there is a period in which a gas region is present in the divided period, a first generation unit 91 sets the period as a second predetermined time period, and in a case where there is no period in which a gas region is present in the divided period, a second predetermined time period is not set in the divided period. This will be described in detail using consecutive three divided periods T1, T2, and T3 illustrated in FIG. 19 as an example. The first generation unit 91 determines whether or not the gas region is included in the monitoring image video V1 in the divided period T1. The gas region is assumed to be included in the monitoring image video V1 in the divided period T1. The first generation unit 91 sets a second predetermined time period (10 seconds) in the period in which the gas region first appears in the divided period T1. The first generation unit 91 generates a representative image Im2 using a part P1 (second time-series image) of the monitoring image video V1 corresponding to the second predetermined time period. Note that the first generation unit 91 may set a second predetermined time period (10 seconds) from the top of the divided period to generate the representative image Im2 even if there is no period in which the gas region is present in the divided period.

The first generation unit 91 determines whether or not the gas region is included in the monitoring image video V1 in the divided period T2. No gas region is assumed to be included in the monitoring image video V1 in the divided period T2. The first generation unit 91 sets a predetermined monitoring image Im1 as a representative image Im2 among a plurality of monitoring images Im1 belonging to the divided period T2. For example, the first monitoring image Im1 is set as a representative image Im2.

The first generation unit 91 determines whether or not the gas region is included in the monitoring image video V1 in the divided period T3. The gas region is assumed to be included in the monitoring image video V1 in the divided period T3. The first generation unit 91 sets a second predetermined time period (10 seconds) in the period in which the gas region first appears in the divided period T3. The first generation unit 91 generates a representative image Im2 using the part P1 of the monitoring image video V1 corresponding to the second predetermined time period.

According to the second variation, throughout the period of the divided periods, a representative image Im2 including no gas region is generated when no gas region is present, and a representative image Im2 including the gas region is generated when there is the gas region in at least a part of the divided period. Therefore, in a case where the gas region is present in a part of the divided period, oversight of the gas region can be suppressed.

The second variation is premised on determination on whether or not the gas region is included in the monitoring image video V1. Accordingly, in the second variation, the above-described second exemplary method of generating the representative image Im2 (the representative image Im2 is determined on the basis of an average luminance value of the gas region) or the third example (the representative image Im2 is determined on the basis of an area of the gas region) is applied.

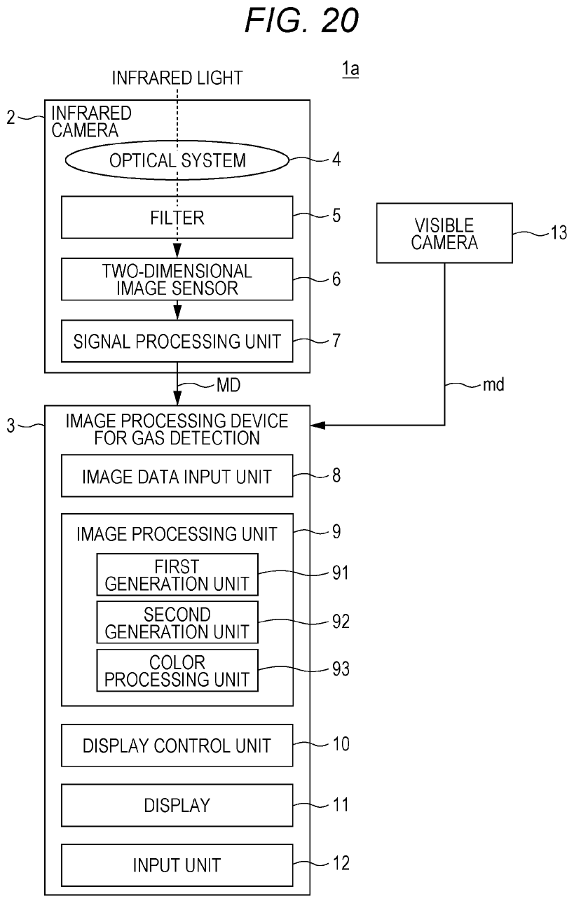

A third variation will be described. In the third variation, a gas region is colored. FIG. 20 is a block diagram illustrating a configuration of a gas detection system 1a according to the third variation of the embodiment. A difference between the gas detection system 1a and the gas detection system 1 illustrated in FIG. 1A will be described. The gas detection system 1a includes a visible camera 13. The visible camera 13 images, in parallel with a moving image of a monitoring target being imaged by an infrared camera 2, a moving image of the same monitoring target. As a result, moving image data and output from the visible camera 13 is input to an image data input unit 8.

An image processing unit 9 of the gas detection system 1a includes a color processing unit 93. The color processing unit 93 performs image processing of colorizing the gas region. The monitoring images Im1 illustrated in FIGS. 14A and 14B will be described in detail as an example. Since the monitoring images Im1 are represented in gray scale, the gas region is also represented in gray scale. The color processing unit 93 performs a process of removing noise (e.g., morphology) on the first monitoring image Im1, and then cuts out the gas region from the first monitoring image Im1.

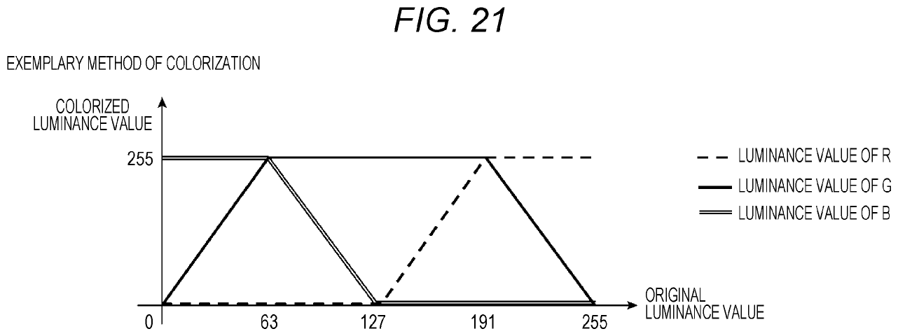

The color processing unit 93 colorizes the gas region according to a luminance value of each pixel included in the cut out gas region. The color processing unit 93 regards a pixel having a luminance value equal to or less than a predetermined threshold value as noise, and does not color the pixel. Accordingly, the color processing unit 93 colors pixels having luminance values exceeding the predetermined threshold value. FIG. 21 is an explanatory diagram illustrating an exemplary method for converting a grayscale region into a colored region. The horizontal axis of the graph illustrated in FIG. 21 represents an original luminance value, and the vertical axis represents respective RGB luminance values. A luminance value of R is 0 when the original luminance value is 0 to 127, which increases linearly from 0 to 255 when the original luminance value is 127 to 191, and is 255 when the original luminance value is 191 to 255. A luminance value of G increases linearly from 0 to 255 when the original luminance value is 0 to 63, which is 255 when the original luminance value is 63 to 191, and decreases linearly from 255 to 0 when the original luminance value is 191 to 255. A luminance value of B is 255 when the original luminance value is 0 to 63, which decreases linearly from 255 to 0 when the original luminance value is 63 to 127, and is 0 when the original luminance value is 127 to 255.

The color processing unit 93 sets three adjacent pixels as one set in the cut out gas region, and calculates an average value of the luminance values of those pixels. This average value is to be the original luminance value. For example, when the average value (original luminance value) is 63, the color processing unit 93 sets, among the tree pixels included in the set, the luminance value of the pixel corresponding to R to 0, the luminance value of the pixel corresponding to G to 255, and the luminance value of the pixel corresponding to B to 255. The color processing unit 93 performs a similar process on other sets as well. Accordingly, the gas region is colorized. When gas concentration is high, the luminance value (pixel value) of each pixel included in the gas region is relatively large, whereby the gas region has a larger red area. When gas concentration is low, the luminance value (pixel value) of each pixel included in the gas region is relatively small, whereby the gas region has a larger blue area.

The color processing unit 93 colorizes the gas region for each of the gas regions included in the 2nd to 16th monitoring images Im1 in a similar manner.

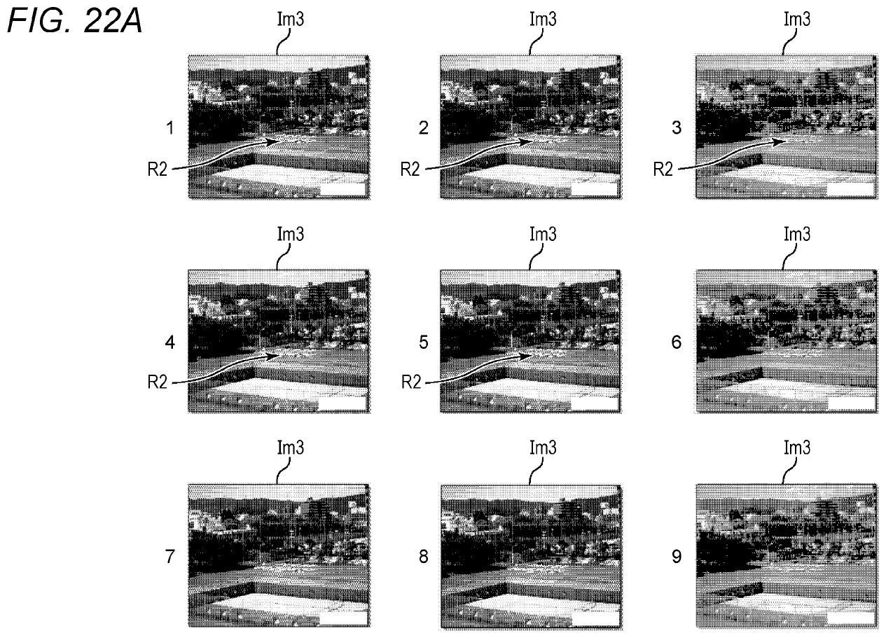

The color processing unit 93 combines the colorized gas region (hereinafter referred to as a colored gas region) with a visible image Im3. More specifically, the color processing unit 93 obtains, from the moving image data md, a frame (visible image Im3) captured at the same time as the monitoring image Im1 illustrated in FIGS. 14A and 14B. The color processing unit 93 combines the colored gas region of the gas region cut out from the first monitoring image Im1 with the frame (visible image Im3) having the captured time same as that of the first monitoring image Im1. The color processing unit 93 performs a similar process on the colored gas regions of the gas regions cut out from the 2nd to 16th monitoring images Im1. FIGS. 22A and 22B are image diagrams illustrating specific examples of the visible image Im3 in which a colored gas region R2 is combined. The visible image Im3 and the monitoring image Im1, which are in the same order, have the same captured time. For example, the first visible image Im3 and the first monitoring image Im1 have the same captured time.

The visible image Im3 is a color image. The colored gas region R2 is combined near the center (spot SP1 in FIG. 3) of the visible image Im3. Among the 16 sheets sampled from 300 sheets for 10 seconds, while the colored gas region R2 clearly appears in the 1st to 5th visible images Im3 and the 15th to 16th visible images Im3 (although it may be difficult to see in the drawing, the colored gas region R2 appears in the actual images), the colored gas region R2 does not clearly appear in the 6th to 14th visible images Im3. This is because the gas region that appears in the monitoring image Im1 illustrated in FIGS. 14A and 14B is reflected.

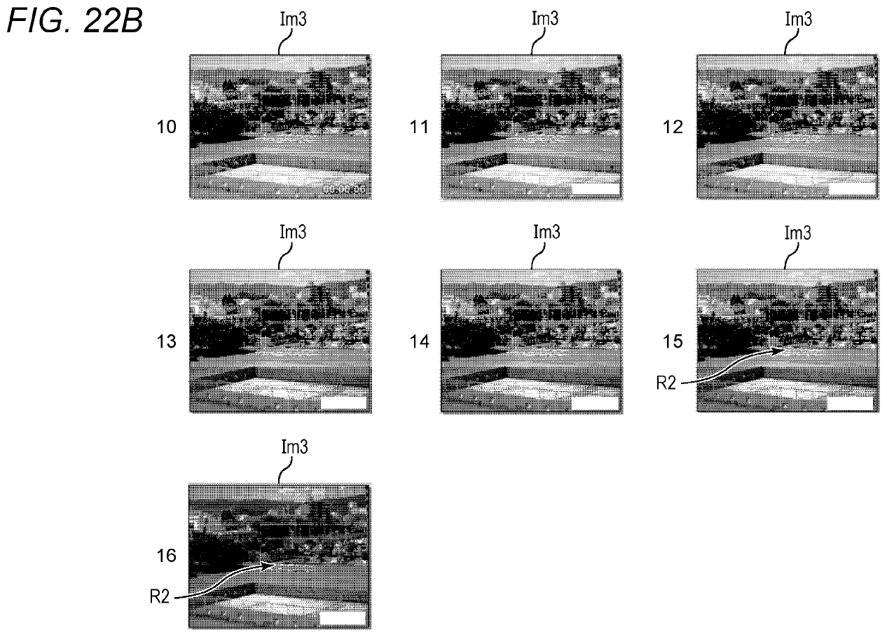

Video of the visible image Im3 in which the colored gas region R2 is combined as illustrated in FIGS. 22A and 22B will be referred to as visible image video V3. FIG. 23 is a schematic diagram illustrating a process of generating representative image video V4 (exemplary time-series representative images) from the visible image video V3 (exemplary first time-series images) according to the third variation of the embodiment.

Referring to FIGS. 20 and 23, the first generation unit 91 generates a representative image Im4 for a part P2 (second time-series image) of the visible image video V3 corresponding to each 10 seconds, thereby generating the representative image video V4. The representative image video V4 includes a plurality of representative images Im4 arranged in a time series. Since the representative image Im4 is created in units of 10 seconds, the number of the representative images Im4 (frames) included in the representative image video V4 is 8,640 (=24 hours×60 minutes×6).

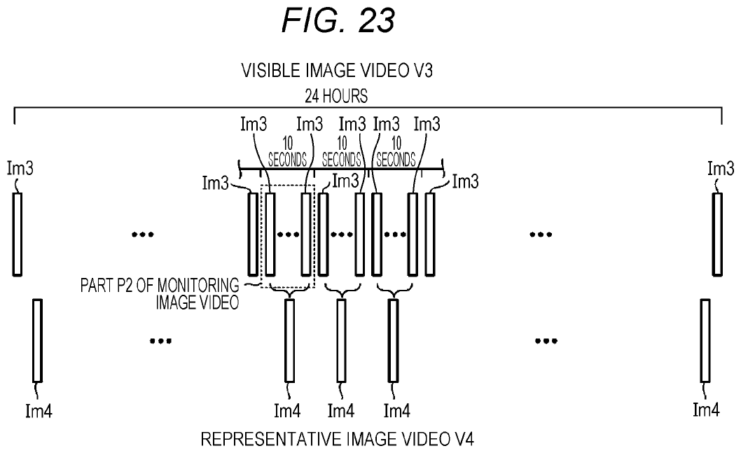

A specific example of the representative image video V4 is illustrated in FIG. 24. FIG. 24 is an image diagram illustrating the representative image video V4 generated using the visible image video V3 for 50 seconds. The image indicated by “11:48” is a representative image Im4 for 10 seconds from 11 minutes 48 seconds to 11 minutes 58 seconds. The image indicated by “11:58” is a representative image Im4 for 10 seconds from 11 minutes 58 seconds to 12 minutes 08 seconds. The image indicated by “12:08” is a representative image Im4 for 10 seconds from 12 minutes 08 seconds to 12 minutes 18 seconds. The image indicated by “12:18” is a representative image Im4 for 10 seconds from 12 minutes 18 seconds to 12 minutes 28 seconds. The image indicated by “12:28” is a representative image Im4 for 10 seconds from 12 minutes 28 seconds to 12 minutes 38 seconds. The colored gas region R2 clearly appears in the representative image Im4 indicated by “11:58” and the representative image Im4 indicated by “12:08” (although it may be difficult to see in the drawing, the colored gas region R2 appears in the actual images).

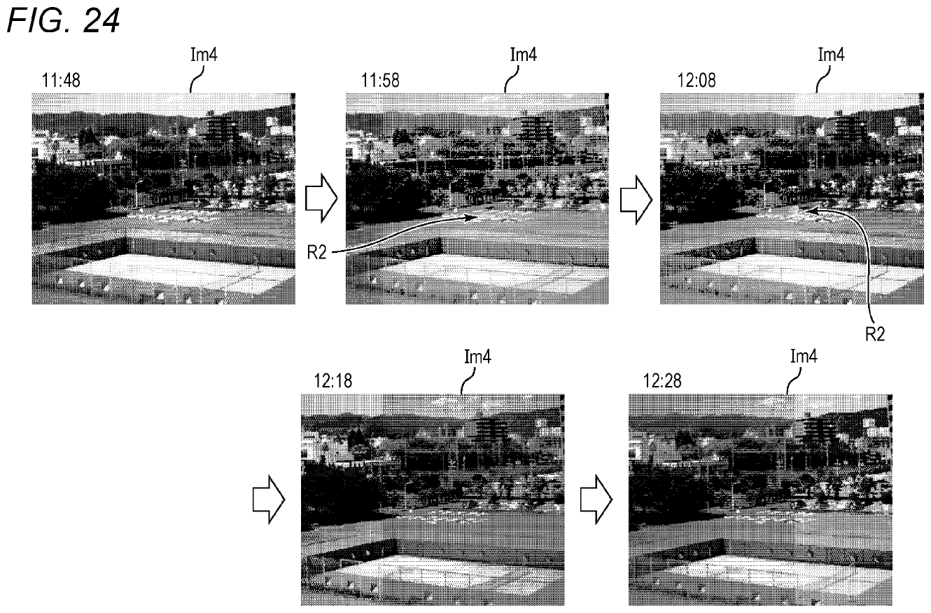

In order to suppress oversight of the colored gas region R2, if the colored gas region R2 is present in at least a part of 10 seconds, the first generation unit 91 causes the representative image Im4 to include the colored gas region R2. A method of generating the representative image Im4 will be described. Referring to FIGS. 20 and 23, the first generation unit 91 performs a process of removing noise (e.g., morphology) on each of a plurality of monitoring images Im3 included in the part P2 of the visible image video V3, and then determines whether or not the colored gas region R2 is included in each of the plurality of visible images Im3. In a case where at least one of the plurality of visible images Im3 includes the colored gas region R2, the first generation unit 91 determines that the part P2 of the visible image video V3 includes the colored gas region R2. In a case where the part P2 (second time-series images) of the visible image video V3 includes the colored gas region R2, the first generation unit 91 calculates an area of the colored gas region R2 for each visible image Im3 including the colored gas region R2 among the plurality of visible images Im3 included in the part P2 of the visible image video V3. A method of calculating the area of the colored gas region R2 is the same as the method of calculating the area of the gas region. The first generation unit 91 selects the visible image Im3 having the maximum area of the colored gas region R2 as a representative image Im4. FIG. 25 is an image diagram illustrating the representative image Im4 generated according to the third variation. The colored gas region R2 clearly appears in the representative image Im4 (although it may be difficult to see in the drawing, the colored gas region R2 appears in the actual image).

The first generation unit 91 determines that the part P2 of the visible image video V3 does not include the colored gas region R2 in the case where any of the plurality of visible images Im3 included in the part P2 of the visible image video V3 does not include the colored gas region R. In the case where the part P2 of the visible image video V3 does not include the colored gas region R2, the first generation unit 91 sets a predetermined visible image Im3 among the plurality of visible images Im3 included in the part P2 of the visible image video V3 as a representative image. The predetermined visible image Im3 may be any one (e.g., the top visible image Im3) as long as it is a plurality of visible images Im3 included in the part P2 of the visible image video V3.

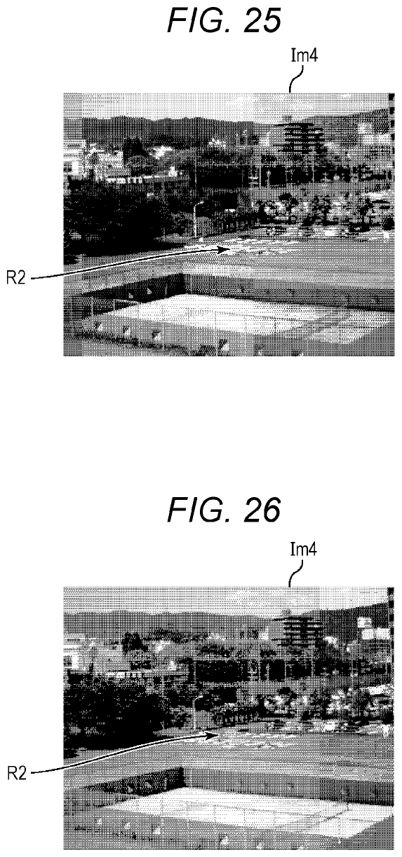

The third variation includes the following second mode in addition to the first mode as described above. The first generation unit 91 and the second generation unit 92 illustrated in FIG. 20 may generate representative image video V2 using the method described with reference to FIGS. 13 to 16 (first exemplary method of generating the representative image Im2), and may generate the representative image video V4 on the basis of the representative image video V2. Specifically, the color processing unit 93 performs a process of removing noise (e.g., morphology) on each of a plurality of representative images Im2 included in the representative image video V2 (FIG. 13), and then determines whether or not the gas region is included in each of the plurality of representative images Im2. The color processing unit 93 cuts out the gas region from the representative image Im2 including the gas region, colorizes the gas region (generates the colored gas region R2) using the method described above, and combines the colored gas region R2 with the visible image Im3 captured at the same time as the captured time corresponding to the representative image Im2. This combined image is to be the representative image Im4 (FIG. 23). FIG. 26 is an image diagram illustrating the representative image Im4 generated according to the second mode of the third variation. The colored gas region R2 clearly appears in the representative image Im4 (although it may be difficult to see in the drawing, the colored gas region R2 appears in the actual image).

As described above, according to the third variation, the gas region included in the representative image Im4 is colorized (colored gas region R2), whereby the gas region can be highlighted. Accordingly, the user can easily find the gas region.

The third variation can be combined with the first variation illustrated in FIG. 18, and can be combined with the second variation illustrated in FIG. 19.

Although the color visible image Im3 has been described as an example of the background of the colored gas region R2 in the third variation, a grayscale visible image Im3 may be used as the background. In addition, an infrared image captured by an infrared camera 2 may be used as the background. The visible camera 13 is not required in the mode of using the infrared image as the background.

### Summary of Embodiment

An image processing device for gas detection according to a first aspect of an embodiment includes a first generation unit that generates time-series representative images by obtaining first time-series images whose imaging time is a first predetermined time period, setting a plurality of second predetermined time periods arranged in a time series and included in the first predetermined time period, and performing, on a plurality of second time-series images respectively corresponding to the plurality of second predetermined time periods, generation of a representative image of the second time-series images corresponding to the second predetermined time periods and to a part of the first time-series images, in which, in a case where the representative image is generated using the second time-series images including a gas region, the first generation unit generates the representative image including the gas region, and a display control unit that displays, on a display, a plurality of the representative images included in the time-series representative images in a time-series order is further provided.

In the first time-series images, a gas monitoring target (e.g., a gas pipe of a gas plant) is captured. The first time-series images may be time-series images having been subject to image processing of extracting a gas region, or may be time-series images not having been subject to such image processing. In the latter case, for example, in a case where liquefied natural gas leaks from a gas pipe, a misty image (gas region) is included in the first time-series image even if the image processing of extracting the gas region is not performed. The image processing of extracting the gas region is not limited to the image processing described in the embodiment, and may be publicly known image processing.

Of the first predetermined time period (first predetermined time period>second predetermined time period), the first time-series image includes the gas region during the period in which the gas to be detected appears or during the period in which an event causing misdetection occurs. Of the first predetermined time period, the first time-series image does not include the gas region during the period in which the gas to be detected does not appear and the event causing the misdetection does not occur.

The representative image is an image representing the second time-series image (a part of the first time-series images). The time-series representative images include a plurality of representative images arranged in a time series. The display control unit displays the plurality of representative images on a display in a time-series order (reproduces the time-series representative images). Therefore, the user can grasp the contents of the first time-series images by viewing those representative images.

In addition, since the representative image is an image representing the second time-series image that is a part of the first time-series images, the number of the representative images included in the time-series representative images is smaller than the number of images included in the first time-series images. Therefore, the time-series representative images can have a shorter reproduction time than the first time-series images.

As described above, according to the image processing device for gas detection of the first aspect of the embodiment, the user can grasp the contents of the time-series images (first time-series images) in a short time.

The first generation unit generates a representative image including the gas region in the case of the second time-series image including the gas region. Therefore, according to the image processing device for gas detection of the first aspect of the embodiment, oversight of the gas region can be suppressed.

The image processing device for gas detection according to the first aspect of the embodiment includes a first mode for determining whether or not the second time-series image includes the gas region, and a second mode for not determining whether or not the second time-series image includes the gas region. In the second mode, a representative image including the gas region is generated as a result if the second time-series image includes the gas region, and a representative image not including the gas region is generated as a result if the second time-series image does not include the gas region.

In the configuration described above, a processing unit for performing image processing of colorizing the gas region is further provided.

According to this configuration, the gas region is colorized, whereby the gas region can be highlighted. Accordingly, the user can easily find the gas region. The gas region may be colorized at the stage of the first time-series images (processing of colorizing the gas region may be performed on a plurality of images included in the first time-series images), or the gas region may be colorized at the stage of the time-series representative images (processing of colorizing the gas region may be performed on a plurality of representative images included in the time-series representative images).

In the above configuration, in a case where the second time-series image includes the gas region, the first generation unit calculates an area of the gas region for each image including the gas region among a plurality of images included in the second time-series images, and selects the image having the maximum gas region area as the representative image.

This configuration is the first mode mentioned above. According to this configuration, in a case where the second time-series image includes the gas region, the area of the gas region included in the representative image can be enlarged. Accordingly, the user can easily find the gas region.

In the above configuration, in a case where the second time-series image includes the gas region, the first generation unit calculates an average luminance value of the gas region for each image including the gas region among the plurality of images included in the second time-series images, and selects the image having the maximum average luminance value of the gas region as the representative image.

This configuration is the first mode mentioned above. According to this configuration, in a case where the second time-series image includes the gas region, the average luminance value of the gas region included in the representative image can be increased. Accordingly, the user can easily find the gas region.

In the above configuration, in a case where the second time-series image does not include the gas region, the first generation unit selects a predetermined image among the plurality of images included in the second time-series images as the representative image.

This configuration is the first mode mentioned above. As described above, the user views the time-series representative images to grasp the contents of the first time-series images in a short time. Accordingly, in a case where there is a second predetermined time period in which no gas region is present in a plurality of the second predetermined time periods, it is necessary for the user to recognize the fact. In view of the above, in the case of the second time-series image corresponding to the second predetermined time period in which no gas region is present (in a case where the second time-series image does not include the gas region), the first generation unit sets a predetermined image (optional image) among the plurality of images included in the second time-series images as a representative image. The predetermined image may be any one (e.g., the top image) as long as it is a plurality of images included in the second time-series images.

In the above configuration, the first generation unit sets a plurality of divided periods obtained by dividing the first predetermined time period, and sets the second predetermined time period included in the divided period and shorter than the divided period for each of the plurality of divided periods.

The total period of the plurality of divided periods is the same length as the first predetermined time period. According to this configuration, since the second predetermined time period is shorter than the divided period, a plurality of second predetermined time periods is to be set at predetermined intervals. According to this configuration, the number of the representative images can be made smaller in the case where the second predetermined time period has the same length compared with the aspect in which the plurality of second predetermined time periods is set to be continuous. Therefore, according to this configuration, even if the first predetermined time period is long, the contents of the first time-series images can be roughly grasped without increasing the reproduction time of the time-series representative images. This configuration is effective in the case where the first predetermined time period is long (e.g., one day).

In the above configuration, in a case where there is a period in which the gas region is present in the divided period, the first generation unit sets the period as the second predetermined time period.

There may be a gas region in a part of divided periods instead of the entire period thereof. When the second predetermined time period is set in the period in which the gas region is present, the first generation unit generates a representative image including the gas region, and when the second predetermined time period is set in the period in which no gas region is included, it generates a representative image including no gas region. This configuration gives priority to the former case. Accordingly, throughout the period of the divided periods, the first generation unit generates a representative image including no gas region when no gas region is present, and generates a representative image including the gas region when there is the gas region in at least a part of the divided period. According to this configuration, oversight of the gas region can be suppressed in the case where there is the gas region in at least a part of the divided period.

In the above configuration, the first generation unit sets the maximum value of the values indicated by the pixels positioned in the same order in the plurality of images included in the second time-series images as a value of the pixel positioned in the same order in the representative image, thereby generating the representative image.

Since the values indicated by the pixels included in the gas region are relatively large, the region including the pixels having relatively large values is the gas region. This configuration is the second mode mentioned above, and a representative image is generated without determining whether or not the gas region is included in the second time-series image. According to this configuration, in a case where the second time-series image includes the gas region, the gas region included in the representative image is to be a gas region indicating a logical sum of the gas regions included in the respective images included in the second time-series images. Therefore, it has been found out that, in a case where the gas fluctuates due to a change in the wind direction or the like, the area of the gas region included in the representative image can be enlarged. In such a case, the user can easily find the gas region.

In the above configuration, the first generation unit sets a plurality of divided periods obtained by dividing the first predetermined time period, and sets the second predetermined time period included in the divided period and shorter than the divided period for each of the plurality of divided periods.

According to this configuration, even if the first predetermined time period is long, the contents of the first time-series images can be roughly grasped without increasing the reproduction time of the time-series representative images. This configuration is effective in the case where the first predetermined time period is long (e.g., one day).

In the above configuration, a processing unit for performing image processing of colorizing the gas region is further provided in the case where the representative image includes the gas region.

This configuration determines whether or not the representative image includes the gas region, and colorizes the gas region in the case where the representative image includes the gas region. Therefore, the gas region can be highlighted according to this configuration.

In the above configuration, there is further provided a second generation unit that generates the first time-series images by performing image processing of extracting the gas region on third time-series images captured during the first predetermined time period.

According to this configuration, the time-series images having been subject to the image processing of extracting the gas region are to be the first time-series images.

An image processing method for gas detection according to a second aspect of the embodiment includes a first generation step of generating time-series representative images by obtaining first time-series images whose imaging time is a first predetermined time period, setting a plurality of second predetermined time periods arranged in a time series and included in the first predetermined time period, and performing, on a plurality of second time-series images respectively corresponding to the plurality of second predetermined time periods, generation of a representative image of the second time-series images corresponding to the second predetermined time periods and to a part of the first time-series images, in which, in a case where the representative image is generated using the second time-series images including a gas region, the first generation step generates the representative image including the gas region, and a display control step of displaying, on a display, a plurality of the representative images included in the time-series representative images in a time-series order is further provided.

The image processing method for gas detection according to the second aspect of the embodiment defines the image processing device for gas detection according to the first aspect of the embodiment from the viewpoint of a method, and exerts effects similar to those of the image processing device for gas detection according to the first aspect of the embodiment.

An image processing program for gas detection according to a third aspect of the embodiment causes a computer to perform a first generation step of generating time-series representative images by obtaining first time-series images whose imaging time is a first predetermined time period, setting a plurality of second predetermined time periods arranged in a time series and included in the first predetermined time period, and performing, on a plurality of second time-series images respectively corresponding to the plurality of second predetermined time periods, generation of a representative image of the second time-series images corresponding to the second predetermined time periods and to a part of the first time-series images, in which, in a case where the representative image is generated using the second time-series images including a gas region, the first generation step generates the representative image including the gas region, and the program further causing a computer to perform a display control step of displaying, on a display, a plurality of the representative images included in the time-series representative images in a time-series order.

The image processing program for gas detection according to the third aspect of the embodiment defines the image processing device for gas detection according to the first aspect of the embodiment from the viewpoint of a program, and exerts effects similar to those of the image processing device for gas detection according to the first aspect of the embodiment.

Although the embodiment of the present invention has been illustrated and described in detail, it is illustrative only and does not limit the present invention. The scope of the present invention should be construed on the basis of the description of the appended claims.

Japanese patent application No. 2017-181283 filed on Sep. 21, 2017, the entire disclosure of which is hereby incorporated by reference in its entirety.

### INDUSTRIAL APPLICABILITY

According to the present invention, it becomes possible to provide an image processing device for gas detection, an image processing method for gas detection, and an image processing program for gas detection.

1. An image processing device for gas detection, comprising:
a hardware processor that generates time-series representative images by obtaining first time-series images whose imaging time is a first predetermined time period, setting a plurality of second predetermined time periods arranged in a time series and included in the first predetermined time period, and performing, on a plurality of second time-series images respectively corresponding to the plurality of second predetermined time periods, generation of a representative image of the second time-series images corresponding to the second predetermined time periods and to a part of the first time-series images, wherein
in a case where the representative image is generated using the second time-series images including a gas region, the hardware processor generates the representative image including the gas region, and
displays, on a display, a plurality of the representative images included in the time-series representative images in a time-series order.

2. The image processing device for gas detection according to claim 1, further comprising:
a processor that performs image processing of colorizing the gas region.

3. The image processing device for gas detection according to claim 1, wherein
in a case where the second time-series images include the gas region, the hardware processor calculates an area of the gas region for each image including the gas region among a plurality of images included in the second time-series images, and selects an image having a maximum area of the gas region as the representative image.

4. The image processing device for gas detection according to claim 1, wherein
in a case where the second time-series images include the gas region, the hardware processor calculates an average luminance value of the gas region for each image including the gas region among a plurality of images included in the second time-series images, and selects an image having a maximum average luminance value of the gas region as the representative image.

5. The image processing device for gas detection according to claim 1, wherein
in a case where the second time-series images do not include the gas region, the hardware processor selects a predetermined image among a plurality of images included in the second time-series images as the representative image.

6. The image processing device for gas detection according to claim 1, wherein
the hardware processor sets a plurality of divided periods obtained by dividing the first predetermined time period, and sets, for each of the divided periods, the second predetermined time period included in the divided period and shorter than the divided period.

7. The image processing device for gas detection according to claim 6, wherein
in a case where there is a period in which the gas region is present in the divided period, the hardware processor sets the period as the second predetermined time period.

8. The image processing device for gas detection according to claim 1, wherein
the hardware processor sets a maximum value of values indicated by pixels positioned in a same order in a plurality of images included in the second time-series images as a value of a pixel positioned in the same order in the representative image, and generates the representative image.

9. The image processing device for gas detection according to claim 8, wherein
the hardware processor sets a plurality of divided periods obtained by dividing the first predetermined time period, and sets, for each of the divided periods, the second predetermined time period included in the divided period and shorter than the divided period.

10. The image processing device for gas detection according to claim 8, further comprising:
a processor that performs, in a case where the representative image includes the gas region, image processing of colorizing the gas region.

11. The image processing device for gas detection according to claim 1, wherein
the hardware processor generates the first time-series images by performing image processing of extracting the gas region on a third time-series image captured during the first predetermined time period.

12. An image processing method for gas detection, comprising:
generating time-series representative images by obtaining first time-series images whose imaging time is a first predetermined time period, setting a plurality of second predetermined time periods arranged in a time series and included in the first predetermined time period, and performing, on a plurality of second time-series images respectively corresponding to the plurality of second predetermined time periods, generation of a representative image of the second time-series images corresponding to the second predetermined time periods and to a part of the first time-series images, wherein
in a case where the representative image is generated using the second time-series images including a gas region, the generating generates the representative image including the gas region, the image processing method for gas detection further comprising:
displaying, on a display, a plurality of the representative images included in the time-series representative images in a time-series order.

13. A non-transitory recording medium storing a computer readable image processing program for gas detection causing a computer to perform:
generating time-series representative images by obtaining first time-series images whose imaging time is a first predetermined time period, setting a plurality of second predetermined time periods arranged in a time series and included in the first predetermined time period, and performing, on a plurality of second time-series images respectively corresponding to the plurality of second predetermined time periods, generation of a representative image of the second time-series images corresponding to the second predetermined time periods and to a part of the first time-series images, wherein
in a case where the representative image is generated using the second time-series images including a gas region, the generating generates the representative image including the gas region, the image processing program for gas detection further causing a computer to perform:
displaying, on a display, a plurality of the representative images included in the time-series representative images in a time-series order.

14. The image processing device for gas detection according to claim 2, wherein
in a case where the second time-series images include the gas region, the hardware processor calculates an area of the gas region for each image including the gas region among a plurality of images included in the second time-series images, and selects an image having a maximum area of the gas region as the representative image.

15. The image processing device for gas detection according to claim 2, wherein
in a case where the second time-series images do not include the gas region, the hardware processor selects a predetermined image among a plurality of images included in the second time-series images as the representative image.

16. The image processing device for gas detection according to claim 2, wherein
the hardware processor sets a plurality of divided periods obtained by dividing the first predetermined time period, and sets, for each of the divided periods, the second predetermined time period included in the divided period and shorter than the divided period.

17. The image processing device for gas detection according to claim 2, wherein
the hardware processor generates the first time-series images by performing image processing of extracting the gas region on a third time-series image captured during the first predetermined time period.

18. The image processing device for gas detection according to claim 3, wherein
in a case where the second time-series images do not include the gas region, the hardware processor selects a predetermined image among a plurality of images included in the second time-series images as the representative image.

19. The image processing device for gas detection according to claim 3, wherein
the hardware processor sets a plurality of divided periods obtained by dividing the first predetermined time period, and sets, for each of the divided periods, the second predetermined time period included in the divided period and shorter than the divided period.

20. The image processing device for gas detection according to claim 3, wherein
the hardware processor generates the first time-series images by performing image processing of extracting the gas region on a third time-series image captured during the first predetermined time period.
